(19) United States
(12) Patent Application Publication
(10) Pub. No.: US 2011/0304577 A1
(43) Pub. Date: Dec. 15, 2011

(54) CAPACITIVE TOUCH SCREEN STYLUS

(75) Inventors: Paul Anson Brown, Sunnyvale, CA (US); Gwen Laura Fisher, Sunnyvale, CA (US)

(73) Assignee: SP CONTROLS, INC., South San Francisco, CA (US)

(21) Appl. No.: 12/827,253

(22) Filed: Jun. 30, 2010

Related U.S. Application Data
(60) Provisional application No. 61/353,788, filed on Jun. 11, 2010.

(51) Int. Cl. G06F 3/044; G06F 3/033

(52) U.S. Cl. 345/174; 345/179

(57) ABSTRACT

In some embodiments, a stylus for providing input to a capacitive touch screen, having a tip including or consisting of conductive felt, which provides a deformable conductive surface for contacting the touch screen. The tip is produced by felting base fibers (which are typically non-conductive) with conductive fibers. In other embodiments, a capacitive touch stylus having at least a first mode of operation and a second mode of operation, and including at least one conductive tip and switched circuitry (preferably, passive circuitry) including at least one switch biased in a default state indicative of the first mode of operation but switchable into a second state indicative of the second mode of operation in response to movement of the tip (typically, in response to exertion of not less than a threshold force on the tip). In some embodiments, a stylus having a conductive tip (e.g., a conductive, felted tip) and including switched circuitry (preferably, passive circuitry) having a first state which couples a capacitance to the tip, where the capacitance is sufficient to allow a capacitive touch screen device to recognize (as a touch) simple contact of the tip on the screen of the touch screen device, and a second state which decouples the capacitance from the tip, thereby preventing the touch screen device from recognizing (as a touch) simple contact of the tip on the screen.

### RELATED APPLICATION

The present application claims the benefit of U.S. Provisional Application No. 61/353,788, filed on Jun. 11, 2010, by Paul Anson Brown and titled “Capacitive Touch Screen Stylus with Deformable Felted Tip and/or Passive Switched Circuitry for Indicating Mode.” U.S. Provisional Application No. 61/353,788 is hereby incorporated by reference herein in its entirety.

### FIELD OF THE INVENTION

The invention pertains to a stylus for use as an input device for a capacitive touch screen and to systems including a stylus and a touch screen device configured to register and to recognize touches of the stylus tip on the touch screen. In an embodiment, the touch screen device includes communication ports (e.g., Bluetooth, USB, RS232, an audio input port, etc.) and a processor coupled to the communication port and to the touch screen, and the stylus includes switched circuitry for communicating stylus events to the processor through the communication port.

### BACKGROUND OF THE INVENTION

The expression “switched circuitry” is used herein to denote circuitry including at least one switch. The switched circuitry may be part of a complete circuit (through which current can flow only when said part is coupled to another part of the circuit) or it may be a complete circuit (through which current flows when each said switch is in a state allowing the current to flow). An example of “switched circuitry” is a set of circuit elements connected in series, where at least one of the elements is (e.g., all of the elements are) included in a stylus, the elements include a switch that is selectively switchable between a closed state and an open state. In an embodiment, the switch is selectively switchable in response to externally applied force e.g., a switch biased in an open state and configured to enter a closed state in response to application of sufficient force on the switch, or a switch biased in a closed state and configured to enter an open state in response to application of sufficient force on the switch, and the switch's state is indicative of a mode of operation of the stylus. Passive switches may also be included.

The term “conductive” is used herein to denote “electrically conductive.”

The expressions “touch screen device” and “touch screen” are used herein as synonyms to denote either a capacitive touch screen or a device (e.g., a portable computing device or handheld phone) that includes a capacitive touch screen. This term is also intended to refer to screens that use projected capacitive touch technology. (“PCT.”) A “touch screen device” (or “touch screen”) includes a screen intended to be touched by human fingers and/or styli and a system for recognizing touches (and strokes) on the touch screen by objects. A “touch screen device” (or “touch screen”) may include a computing system (sometimes referred to herein as a “processor”) configured to display images on the screen and/or perform other operations in response to recognized touches or strokes on the screen. A “touch screen device” or “touch screen” may also include other subsystems e.g., an audio subsystem including at least one audio input port and at least one audio output port, and configured to assert output an audio signal at each audio output port and to receive analog audio at each audio input port and to generate digital audio data by sampling the received audio.

Capacitive and PCT touch screens have become ubiquitous in handheld phones and computing devices. These touch screens present unique challenges for the design of styli that can serve as input devices to them. It is problematic to use a stylus as an input device for a capacitive touch screen originally designed for actuation based on the capacitive coupling of a human finger, for several reasons including the following:

the stylus must mimic the capacitive load of a human finger and provide a coupling area sufficient for the touch screen circuitry to be fooled into responding as if to the contact of a human finger;

the stylus tip must provide capacitive coupling approximate to the capacitive coupling of a human finger. This usually means that the tip must itself be a conductive surface. The stylus tip also should not scratch the surface of the touch screen. Conductive, deformable, non-scratching, low friction, inexpensive materials present a unique design challenge; and

capacitive touch screens technologies often use a high precision glass pane that provides the contact surface for the human finger. To use a stylus on this smooth glass surface, one must have a stylus tip that is capable of creating a coupling point that is large enough to meet a two dimensional minimum contact area that allows the touch screen to calculate a centroid from the outline of the contact area.

Conventional proposals for solving this problem are sub-optimal, and use stylus tips that:

(A) provide a deformable or pliable surface (typically a conductive surface of hemispherical or conical shape when not deformed), comprise an elastomeric (or flexible polymeric) material that is either bare or covered by a conductive (or thin, non-conductive) layer, and are deformable when pressed against a touch screen to contact a region of the screen having sufficiently large area for recognition by the touch screen device (see, for example, US Patent Application Publication Nos. 2008/0297491 A1 and 2009/0262637A1); or

(B) include an articulated disk or semi-flattened sphere on a ball joint that provides a two-dimensional coupling area that meets the minimum requirement (see, for example, US Patent Application Publication Nos. 2010/0006350 A1 and 2009/0211821 A1); or

(C) consist of a mass of metal wires (see, for example, US Patent Application Publication No. 2008/0297491 A1) or include a cover of conductive fabric containing conductive wires over a flexible, conductive region (see, for example, US Patent Application Publication No. 2009/0262637A1).

Styli that employ method (C) are sub-optimal since a stylus tip surface of metal wires (or conductive fabric containing wires) would be abrasive and tend to scratch or abrade a touch screen surface.

Styli that employ method (A) are sub-optimal since any elastomer acts like a spring, and elastomeric or flexible polymeric material having hemispheric (or conical or similar) shape sliding on a touch screen has an increased coefficient of friction as the material deforms in response to being pressed against the screen (to provide a sufficiently large two-dimensional coupling surface area with the screen). The increased coefficient of friction (especially when it is due to a deformed elastomer that exerts spring force on a touch screen against which it is pressed) impedes the glide of the stylus tip across a touch screen, thus making it more difficult for the user to write or draw with the touch screen device. An elastomeric stylus tip covered with a conductive wire mesh (e.g., as disclosed in US Patent Application Publication No. 2008/0297491 A1), or a stylus tip comprising a pliable cover (e.g., conductive fabric containing conductive wires, or elastomeric or plastic material embedded with conductive material, or thin non-conductive material) over conductive, elastomeric (or polymeric), flexible material (e.g., as disclosed in US Patent Application Publication No. 2009/0262637A1), is not immune to problems due to increased coefficient of friction with increasing deformation. The level of friction between such a conventional stylus tip and a touch screen requires a design balance in which the designer must either choose to make the material in contact with the screen soft enough to prevent the glass surface from being abraded over time versus making the tip material durable enough to last a long time. It had not been proposed before the present invention to provide a capacitive touch screen stylus with a tip of conductive felted material (comprising non-conductive fibers felted with conductive fibers) to reduce or eliminate conventional touch screen stylus problems in due to undesirable levels of friction and abrasiveness.

Styli that employ method (B) have the problem that the disk requires a pivot point that increases cost and fragility of the device. Furthermore, as the disk makes contact with the touch screen when used as a writing implement it is unreasonable to assume that the user will always keep the disk perfectly parallel to the plane of the touch screen when raising and lowering the stylus tip, thus provoking an incorrect centroid calculation during the time between the edge of the disk making contact and the full disk area seats onto the plane of the glass surface. This would result in an unintentional user stroke to be recorded by the device.

It would be desirable to implement a stylus as an input device for a capacitive touch screen in a manner that overcomes the limitations and disadvantages of conventional styli intended for use for this purpose.

Capacitive and PCT touch screens are typically optimized for use with human fingers. However, humans have spent a considerable amount of time building dexterity to write using a stylus pen or pencil. Writing or drawing with a finger is cumbersome and difficult. Conventional capacitive touch screens typically operate with host software (e.g., are coupled to processors programmed to execute host software) that recognizes gestures of single or multiple touches on the screen. When using a stylus as an input device for a conventional touch screen, problems due to unintended touches on the screen can arise. A natural way to write on any surface with a stylus (e.g., pen or pencil) involves resting the base of the hand as a fulcrum and using the thumb and other fingers to guide the movement of the stylus. Given a large enough touch screen, the base of the user's hand (as well as the stylus) touches the screen during writing.

The inventor has recognized that an important problem to be addressed in order to use a stylus as an input device for a capacitive touch screen device (sometimes referred to herein as the “disambiguation problem”) is how to allow the touch screen device (sometimes referred to herein as a “host device”) to distinguish between a user-intended stylus tip touch on the screen, and an unintended touch on the screen (e.g., a touch on the screen by a user's hand gripping a stylus, or another object that is not the stylus tip, which is not intended to provide input to the touch screen device). The touch screen device (e.g., host software running on the device) must disambiguate intended writing (or other input strokes or touches) from unintended touches (e.g., by the base of the user's hand) to provide stability. It would be desirable to implement a stylus and/or host device in a manner that addresses the disambiguation problem in an efficient and inexpensive manner (e.g., without unacceptable cost and complexity in design and manufacture of the stylus, and preferably without requiring that the host device include any hardware that is not typically included in a conventional version of the host device).

A capacitive touch screen device typically must be able to recognize whether a touch on a screen is a finger touch or a stylus touch. A conventional proposal for achieving this (described in above-cited US Patent Application Publication No. 2010/0006350 A1) uses a powered stylus equipped with sensors and switches for selecting modal data to be asserted to the touch screen device via wireless communication and/or direct stimulation of the capacitive touch screen.

### BRIEF DESCRIPTION OF EMBODIMENTS OF THE INVENTION

In a first class of embodiments, the invention is a stylus for providing input to a capacitive touch screen. The stylus has a tip comprising (i.e., consisting of) conductive felt, which provides a deformable conductive surface for contacting a touch screen (with a sufficiently large contact area to allow the touch screen to recognize a touch by the tip). Typically, the tip is sufficiently smooth to be capable of being moved in contact with the touch screen with less than an undesirable amount of friction (between the tip and touch screen surface in contact therewith), in the sense that a user who moves the stylus on the screen to write with the stylus feels no more friction (between the stylus and the screen surface) than is typical during writing with a conventional pencil or pen on paper. The tip comprises first fibers (which are sometime referred to herein as “base” fibers, and are typically non-conductive) and conductive fibers, and is produced by felting the base fibers with the conductive fibers using the fiber material technique commonly known as felting. The base fibers are selected to be conducive to felting (i.e., to have properties at the microscopic level that allow them to bond and tangle with one another in the presence of water and agitation), and to have sufficient smoothness to produce sufficiently low friction when used (after being felted) as a capacitive touch screen stylus tip, and preferably to have low cost. During the felting process, the base fibers capture the conductive fibers and through specific felting techniques form an at least substantially spherical or hemispherical felt object (or a felt object of other shape) that is semi-rigid (in the sense in the sense that it retains its shape unless and until it is deformed by forcing it against a touch screen or other object), and can be mounted to a distal end of a support to form a stylus. In use of the stylus, the felt object functions as a conductive stylus tip that couples a sufficient capacitance to a touch screen, at a contact region on the screen of sufficient area, to allow recognition of a touch by the tip.

The technique for manufacturing typical embodiments of the stylus tip starts with a base fiber (preferably a common, inexpensive base fiber) that is already conducive to felting. Wool or any other fiber that has scales which interlock at the microscopic level during a felting process is suitable as a base fiber in many embodiments. Interspersing this base fibers with conductive fibers, which typically do not have the same microscopic characteristics necessary for felting, allows the base fibers to lock and hold the strands of the conductive fibers. The felting should produce a semi-rigid, felt object having shape suitable for use as the tip of a capacitive touch screen stylus (e.g., spherical, hemispherical or bullet-like shape), and size suitable for affixing to the end of a capacitive touch screen stylus body (e.g., a conductive rod or tube, or a non-conductive tube including or coupled to a capacitance, where the capacitance is connected by a conductor to the felt object in at least one operating mode). When the stylus has a conductive body, the conductive body (and optionally a conductive structure between the felt tip and the conductive body) couples with the human hand and therefore provides a low impedance path between the conductive felted tip and the human body, allowing a capacitive touch screen to properly calculate a centroid based on the area of contact between the tip and the screen. By using base fibers of sufficiently low friction (when felted) in the tip, the coefficient of friction of the felted tip against the glass surface of a capacitive touch screen is significantly low to allow for a natural (pen-like) feel of the stylus as the tip slides on (or is touched against) the screen.

The blending percentage of the conductive fibers and diameter of the felted tip can be chosen to be optimal for the intended use of the capacitive touch screen stylus. The minimum capacitive load to be coupled via the tip, and the minimum two-dimensional contact area of the tip with the screen, will depend on the host device with which the stylus is used. The conductive fibers can be any fibers that inherently (or are modified to) have electrical resistivity preferably less than 10,000 ohms-cm (and not more than on the order of 10,000,000 ohms-cm). To produce the tip, the base and conductive fibers are mixed in a ratio sufficient for the tip to have sufficient conductivity to provide the electrical coupling necessary for a stylus including the tip to stimulate a capacitive touch screen. The tip's conductive fibers (rather than any other element of the tip) provide the tip's conductivity that is required for its intended use (e.g., the conductive tip is normally used when dry, but even if it happens to be used when wet with a conductive liquid or contaminated with a conductive substance, it does not rely on the liquid's or the contaminant's conductivity to be useful as a capacitive touch screen stylus tip).

Examples of conductive fibers suitable in typical embodiments include but are not limited to carbon fibers, fibers coated with metal, and fibers coated with carbon. The exemplary conductive fibers have low-friction and non-abrasiveness properties similar to those of typical base fibers with which they are felted. Thus, when felted with the base fibers to produce a stylus tip, the tip can have acceptably low friction and non-abrasiveness. In contrast, metal wires are typically more abrasive than the exemplary conductive fibers. Thus, a tip consisting (or including a significant quantity) of metal wires would typically abrade the surface of a touch screen during use.

In some embodiments, the tip comprises 1/3 conductive fibers and 2/3 base fibers. The conductive fibers may comprise Jarden materials RESISTAT® TYPE F9216, merge L040, nylon electrically conductive with carbon suffused onto the fiber surface, cut into 4 inch lengths and having a resistance of 4000 ohm/cm. The base fibers may comprise 18.5 micron Merino wool fibers. In this instance, 0.06 grams total material felts into a ball approximately 0.250″ in diameter. The weight is approximately 0.05 grams per piece. A 1/16″ diameter brass rod approximately 1.85″ long may be utilized as support structure for the tip. The tip may be constructed by mixing the wool base fiber with the conductive fiber using a drum carder to achieve uniform mixing. The material is weighed and separated into 0.06 gram amounts. Balls are spun in a toroidal shaped grooved mold with a standard hand drill @ 1000 RPM under hot tap water utilizing Dr. Bronner's soap as a lubricant. The balls are then left to air dry. The air dried balls are then drilled 50% through and the brass rod is inserted into the resulting hole and affixed utilizing standard 5 minute epoxy.

In some embodiments, the above-mentioned conductive and base fibers are mixed according to the 1/3 conductive fiber, 2/3 wool fiber ratio. The mixture strands are then felted into a cord by adding water and soap and hand rolling and stretching the cord to achieve a uniform cylinder with a circular cross-section. The cylindrical diameter may be ⅛″. The strands are then cut into desired lengths, e.g. 0.25″. The brass rod is then inserted into the center of one circular face of the cylinder and epoxied into place utilizing, for example, standard 5 minute epoxy. The other circular face of the cylinder may then be trimmed to provide a hemispherical end to the cylinder to make the tip structure “bullet” shaped.

The blending percent also depends upon the shape of the final felted product as well as the means by which it is felted or the fibers are otherwise combined prior to needle felting or felting with water. For example, when the fibers are organized such as through knitting, crocheting, braiding, knotting, weaving and/or spinning into multiple plies, the conductive properties are reduced, thereby requiring a higher percentage of conductive fiber in the felting mix. When using a mixture of 50% conductive fibers and 50% base fibers (by weight), one can knit an I-cord (a spiral knit tube also called idiot cord) to make a tip with the necessary conductive properties. By knitting the I-cord before needle felting or wet felting, the fibers are pre-tangled before felting, resulting in a tip that holds its shape over use with time. When a tip is cut from either end of a felted I-cord, the tip has a bullet shape with a rounded end that is finished and will not splay, unravel, or wear as quickly with use as a tip that is made from a cut end of yarn that has been needle felted and wet felted.

In other embodiments, wool roving is spun into a single ply of yarn, which is needle felted by poking repeatedly with barbed felting needles on top of a foam base. Then, the needle felting yarn is wet felted by rolling the yarn back and forth under hot tap water utilizing Dr. Bronner's soap as lubricant. The yarn is then left to air dry and cut into 11 mm segments. One end of each segment is further cut to achieve a rounded, hemispherical tip. The tips are drilled 0.25 inches through their length, and the brass rod is inserted into the resulting hole and affixed utilizing standard epoxy.

In a class of embodiments, the invention is a stylus for providing input to a capacitive touch screen, said stylus comprising:

a shaft; and

at least one felted tip supported by the shaft, wherein each said felted tip is electrically conductive and deformable, and includes base fibers and conductive fibers felted with the base fibers.

Typically, the felted tip is semi-rigid (in the sense that it retains its shape unless and until it is deformed by forcing it against a touch screen or other object), has been produced by a process including a felting step, and the base fibers are structured such that the felting step results in felted material having interlocking bonds and/or tangles between the base fibers and the conductive fibers that provide the semi-rigidity. Typically, the felted tip is sufficiently rigid to be functional as a touch screen stylus tip without any internal structure being inserted within it to provide support and/or rigidity, In some embodiments, however, the felted tip comprises a conductive, felted outer layer, and a conductive supporting structure within the outer layer. In typical embodiments, the tip is mounted to a conductive post or wire (or other conductive structure) such that the tip and conductive structure are translatable together as a unit relative to the rest of the stylus. Such conductive structure may extend into the tip. The size and shape of the felted tip (sometimes referred to as a “contact” tip) are such that the felted tip at an end of a stylus can contact the touch screen (in an undeformed state and/or a deformed state resulting from deformation in response to being forced against the screen) at a coupling area sufficient to stimulate the touch screen (e.g., detection circuitry in the touch screen) to recognize a distinct touch by the stylus.

In some embodiments, the undeformed contact tip may be hemispherical (i.e., its distal surface which contacts a touch screen, when it is mounted in a stylus) or spherical. In other embodiments, its distal surface (which contacts a touch screen) is a truncated cone, or a three-dimensional parabloid, cylindrical or bullet-like.

In some embodiments, the shaft provides a low impedance path capable of coupling the capacitance, of the hand (or body) of a user who grips the stylus, via the felted tip, to a touch screen (when the felted tip is in contact with the touch screen). In other embodiments, the stylus includes at least one switch between the felted tip and the shaft. When the switch is closed the stylus provides a low impedance path capable of coupling the capacitance, of the hand (or body) of a user who grips the stylus, via the felted tip, to a touch screen (when the felted tip is in contact with the touch screen). When the switch is open, the stylus does not couple the capacitance of the hand (or body) of a user who grips the stylus via the felted tip to a touch screen and the touch screen thus cannot register (recognize) a touch of the felted tip on the touch screen.

In other embodiments, the stylus includes switched circuitry (including at least one switch coupled directly or indirectly to an internal capacitance) between the felted tip and the shaft. When the switch is closed the stylus provides a low impedance path capable of coupling the capacitance to a touch screen (when the felted tip is in contact with the touch screen). When the switch is open, the stylus does not couple the capacitance via the felted tip to a touch screen and the touch screen thus cannot register (recognize) a touch of the felted tip on the touch screen.

In other embodiments, the stylus includes switched circuitry (including at least one switch) and a capacitance (e.g., the capacitance of a cable or the combined capacitance in conjunction with another object coupled to the stylus) is coupled to the switched circuitry. When the switch is closed, the stylus provides a low impedance path capable of coupling the capacitance to a touch screen (when the felted tip is in contact with the touch screen). When the switch is open, the stylus does not couple the capacitance via the felted tip to a touch screen and the touch screen thus cannot register (recognize) a touch of the felted tip on the touch screen.

In a second class of embodiments, the invention is a capacitive touch stylus having at least a first mode of operation and a second mode of operation, and including at least one conductive tip (each, preferably, a conductive felted tip) and switched circuitry (preferably, passive switched circuitry) including at least one switch biased in a default state indicative of the first mode of operation but switchable into a second state indicative of the second mode of operation in response to movement of the tip (typically, movement of the tip in response to exertion of not less than a threshold force on the tip, e.g., by a touch screen in response to user-exerted pushing force on the stylus against the screen), where the switch is coupled to the tip in one of the default state and the second state. The switched circuitry preferably also includes a stylus audio port set, including at least one audio port configured to be coupled to an audio cable. In typical embodiments in the second class, the stylus audio port set includes at least one audio input port, and at least one audio output port, and optionally also a ground port. Preferably, the stylus audio port set is configured to be coupled to an end of a conventional audio cable including left and right output channel connectors, a microphone channel connector, and a ground connector, so that another end of the cable can be coupled to an audio port set (referred to herein as a “host audio port set”) of a touch screen device, where the touch screen device includes an audio subsystem including the host audio port set, and the host audio port set typically includes least two audio output ports (configured to assert left and right output audio channels), an audio output port (configured to receive an audio input from a microphone), and a ground port.

Typically, the first mode of operation is use of the stylus with its tip in contact with a capacitive touch screen (or other object) with not less than a threshold force being exerted by the object on the tip, and the second mode of operation is other use of the stylus (e.g., use with the tip in contact with an object with less than the threshold force exerted by the object on the tip). In other typical embodiments, the first mode of operation is use of the stylus with its tip in contact with a capacitive touch screen (or other object) with not less than a threshold force being exerted by the object on the tip and the stylus gripped by a user (such that not less than a threshold capacitance is coupled from the user to the tip), and the second mode of operation is other use of the stylus (e.g., use with the tip in contact with an object with less than the threshold force exerted by the object on the tip, or with less than the threshold capacitance coupled from to the tip).

In other typical embodiments, the first mode of operation is use of the stylus with occurrence of two events within a predetermined time window of each other: a threshold capacitance is coupled to the tip (e.g., a capacitance internal to the stylus, or external to the stylus but coupled to the stylus by the switched circuitry) in response to exertion of not less than a threshold force on the tip (e.g., by a capacitive touch screen or other object in contact with the tip, as the tip is forced against the object); and a signal is asserted (e.g., for transmission via an audio cable or other wired link, or a wireless link, to a touch screen device) other than by coupling a capacitance to the tip, but in response to exertion of force on the tip (e.g., by a capacitive touch screen or other object in contact with the tip). In these embodiments, the second mode of operation is other use of the stylus (e.g., use with occurrence of one but not both of these events, or with both of the events occurring but not within a predetermined time window). The predetermined time window is typically sufficiently wide to allow processing circuitry in a host (touch screen) device to recognize and distinguish between the two events, but sufficiently short so that both events occur in response to a single touch of the stylus on a capacitive touch screen by a user who intends to indicate information to the touch screen device. In some cases, the first mode is indicated by two switches (of the switched circuitry) changing state within the predetermined window. In some other cases, the first mode is indicated by one switch (of the switched circuitry) changing state twice within the predetermined window.

In some embodiments in the second class, the stylus has a conductive tip (e.g., a conductive, felted tip) that is continuously coupled to a sufficient capacitance (when a human user grips the stylus or through a stylus body of sufficient capacitance) to allow a capacitive touch screen device to recognize (as a touch) simple contact of the tip on the screen of the touch screen device, and the switched circuitry has a first state which allows the stylus to assert to the touch screen device (e.g., forward to, or loop back from, the touch screen device) a signal (when the stylus is coupled by an audio cable or other link to the touch screen device) that indicates to the touch screen device that the screen (or another object) is exerting at least a threshold force on the stylus tip. The switched circuitry also has a second state which prevents the stylus from asserting such signal to the touch screen device, thereby indicating to the touch screen device that the screen (or other object) is not exerting force (or is exerting less than the threshold force) on the stylus tip.

In some embodiments in the second class, the stylus has a first conductive tip at one end (e.g., a conductive felted tip), and a second conductive tip at another end (e.g., another conductive felted tip). The first conductive tip (e.g., at a “writing” end of the stylus) is configured to be moved into a position causing the switched circuitry to enter a first state coupling a capacitance to the tip and opening (open-circuiting) a loop between a first input port (e.g., a left audio channel input port) of the stylus audio port set and at least one output port of the stylus audio port set, where the capacitance is sufficient to allow a capacitive touch screen device (e.g., a conventional capacitive touch screen device) to recognize (as a touch) simple contact of the first conductive tip on the screen of the touch screen device. Preferably, the switched circuitry is implemented so that both these events (coupling of the capacitance to the first conductive tip, and opening the loop between the first input port and said at least one output port of the stylus audio port set) occur within a predetermined time window. In response to the first conductive tip being in another position, the switched circuitry enters a second state decoupling the capacitance from said first conductive tip and/or closing the loop between the first input port and said at least one output port of the stylus audio port set. The second conductive tip (e.g., at an “erasing” end of the stylus) is configured to be moved into a position causing the switched circuitry to enter a third state coupling a capacitance to the tip and opening (open-circuiting) a loop between a second input port of the stylus audio port set (e.g., a right audio channel input port) and at least one output port of the stylus audio port set, where the capacitance is sufficient to allow a capacitive touch screen device (e.g., a conventional capacitive touch screen device) to recognize (as a touch) simple contact of the second conductive tip on the screen of the touch screen device. Preferably, the switched circuitry is implemented so that both these events (coupling of the capacitance to the second conductive tip, and closing the loop between the second input port and said at least one output port of the stylus audio port set) occur within a predetermined time window. In response to the second conductive tip being in another position, the switched circuitry enters a fourth state decoupling the capacitance from the second conductive tip and/or closing the loop between the second input port and said at least one output port of the stylus audio port set.

In some embodiments, the invention is a system including a stylus (which belongs to the second class of embodiments), a touch screen device having an audio subsystem (including a host audio port set of the type mentioned above) and a processor coupled to the audio subsystem, and an audio cable connected between the stylus audio port set of the stylus and the host audio port set of the touch screen device, wherein the processor of the touch screen device is configured to recognize an operating mode of the stylus in response to at least one response signal received at the host audio port set in response to assertion of at least one signal from the audio subsystem via the host audio port set and the cable to the stylus audio port set.

In some embodiments, the state of the stylus audio port set (e.g., in response to the state of the host stylus audio port set) is indicative of one or more of: contact between a tip of the stylus and a touch screen (or other object); pressure exerted by a touch screen (or other object) on a tip of the stylus; state of at least one sensor of the switched circuitry; and state of at least one switch of the switched circuitry. In some such embodiments, the switched circuitry includes at least one filter coupled and configured to filter at least one signal received from a touch screen device (via an audio cable) at the stylus audio port set, thereby generating a filtered signal, and the switched circuitry is configured to assert the filtered signal at the stylus audio port set (for transmission to the touch screen device (via the audio cable).

Typical embodiments in the second class provide a means for communicating mode information from a stylus to a host that allows the host to distinguish between intended touches of the stylus (on a capacitive touch screen) and other touches not intended to be strokes or other kinds of drawing/writing information (such as erasures). Rather than to assert mode information actively from a locally powered (active) stylus (including powered sensors and/or switches for determining and asserting the mode information) via wireless communication to or direct stimulation of the host, preferred embodiments of the invention use purely passive switched circuitry in a stylus to assert mode information to a host via a conventional audio port set conventionally present in the host and a cable coupled between the stylus and the host. These preferred stylus embodiments do not pulse or otherwise communicate any information through a stylus tip by means of electrical stimulation of the host device's touch sensing circuitry other than simple contact (which is recognizable in a conventional manner by a conventional touch screen device).

In a third class of embodiments of the stylus, the stylus has a conductive tip (e.g., a conductive, felted tip) and includes switched circuitry (preferably, passive switched circuitry) having a first state which couples a capacitance to the tip, where the capacitance is sufficient to allow a capacitive touch screen device (e.g., a conventional capacitive touch screen device) to recognize (as a touch) simple contact of the tip on the screen of the touch screen device, and a second state which decouples the capacitance from the tip, thereby preventing the touch screen device from recognizing (as a touch) simple contact of the tip on the screen. The capacitance can be a capacitive load external to the stylus (e.g., the capacitive load of a user's body which can be coupled to the switched circuitry by a conductive shaft of the stylus, or another capacitive load which can be coupled to the switched circuitry) or internal to the stylus (e.g., it can be a capacitor of the switched circuitry). Typically, the switched circuitry (e.g., passive switched circuitry) includes at least one switch biased in a default state which couples the capacitance to (or decouples the capacitance from) the tip but is switchable into a second state which decouples the capacitance from (or couples the capacitance to) the tip in response to movement of the tip (typically, movement of the tip in response to exertion of not less than a threshold force on the tip, e.g., by a touch screen in response to user-exerted pushing force on the stylus against the screen), where the switch is coupled to the tip in one of the default state and the second state. The switched circuitry also includes a stylus audio port set, including at least one audio port configured to be coupled to an audio cable. In typical embodiments in the third class, the stylus audio port set includes at least one audio input port, and at least one audio output port, and optionally also a ground port. Preferably, the stylus audio port set is configured to be coupled to an end of a conventional audio cable including left and right output channel connectors, a microphone channel connector, and a ground connector, so that another end of the cable can be coupled to an audio port set (referred to herein as a “host audio port set”) of a touch screen device, where the touch screen device includes an audio subsystem including the host audio port set, and the host audio port set typically includes least two audio output ports (configured to assert left and right output audio channels), an audio output port (configured to receive an audio input from a microphone), and a ground port.

The switched circuitry of some embodiments of the stylus has a state (e.g., determined by at least one switch actuatable by force of contact of the stylus tip with any surface, e.g., a touch screen) in which it couples an internal capacitive load (internal to the stylus) to the stylus tip. The switched circuitry of other embodiments of the stylus has a state (e.g., determined by at least one switch actuatable by force of contact of the stylus tip with any surface) in which it couples to the tip an external capacitive load (e.g., connects the tip to a conductive shaft of the stylus and thereby to the capacitance of a user's hand gripping the shaft, or couples to the tip another capacitance external to the stylus). In some embodiments, the switched circuitry includes another switch or sensor actuatable by a first tip of the stylus to close or open a circuit path between a first audio output channel (of an audio cable coupled between the stylus and a host) and a microphone input channel (of the cable) to allow routing of a signal (from the host) back to the host either at full strength or attenuated in proportion the contact force on the first tip. In some embodiments, a second tip at the opposite end of the stylus has similar properties, and the switched circuitry also includes switch or sensor actuatable by the second tip to close or open a circuit path between a second audio output channel (of an audio cable coupled between the stylus and a host) and a microphone input channel (of the cable) to allow routing of a signal (from the host) back to the host either at full strength or attenuated in response (e.g., proportionally) to the contact force on the second tip.

Audio signals generated by a host (e.g., comprising frequency components of multiple frequencies that are mixed together, or pulse trains) can be asserted via an audio cable to the stylus. These signals can be returned (looped back, with optional attenuation) to the host, or not returned to the host, depending on the state of passive switched circuitry in the stylus. For example, signals asserted to the stylus on left and right audio channels could have different frequency content (e.g., one could comprise frequency components in a first band; the other comprising frequency components in a different band) for easier discrimination processing (by the host) of signals returned to the host from the stylus.

The switched circuitry of the stylus can include one or more switches, or at least one switch and at least one variable circuit element (e.g., a sensor or source) whose state is determined by sensor input (e.g., force, slider position, or position of a rotatable annular ring). Each switch of the switched circuitry has a subset of the functions of one type of variable sensor, in the sense that the switch has either of two states (0 or 100%), whereas the sensor can be indicative of more than two states (e.g., a continuous range of levels). One type of sensor of the switched circuitry is (or includes or is coupled to) a filter configured to filter a signal (e.g., an audio signal) from a host, so that when the filtered signal is returned to the host (e.g., via the microphone input channel of an audio cable between the stylus and host) the host can process the filtered signal to determine the output of the relevant sensor (and/or to identify which of several sensors in the stylus the signal is indicative of).

In some embodiments, the switched circuitry of the stylus presents a capacitive load (i.e., couples the load through a closed switch and conductive material of the stylus body from a user's hand which grips the body, or from a capacitor within or external to the stylus. In the latter case, the stylus body can be insulating) to the stylus tip (in contact with a touch screen) and thereby to conventional touch screen sensors to cause the touch screen to sense a “touch” event (“Event 1”). The switch which presents this load to the stylus tip may be biased to be open when less than a threshold force is exerted on the tip (e.g., by a capacitive touch screen in contact with the tip). However, this in itself does not disambiguate between a stylus tip touch and a finger (or hand) or other non-stylus touch. Thus, the switched circuitry can include at least one other switch which, when closed (by “Event 2”), closes a loop between the stylus and the host touch screen device, said loop including an audio output channel (of a cable connected between the stylus and the host), circuit elements in the stylus, and another channel (e.g., a microphone input channel) of the cable. In response to Event 2, circuitry in the touch screen device (e.g., audio circuitry which is normally used to process microphone input signals) also senses a “tip” event (and optionally also receives and recognizes the output of one or more sensors and/or switches within the stylus). Circuitry in the touch screen device interprets, as a stylus touch, the occurrence of “Event 1” within a predetermined time window (“x” seconds) of “Event 2.” Circuitry in the touch screen device interprets, as a non-stylus touch, the occurrence of an “Event 1” that is not followed within x seconds (or not preceded by x seconds, in some embodiments) by an “Event 2.” The duration of the window “x seconds” is preferably predetermined in a manner that depends on expected processing delays (e.g., the delay inherent in any required Fourier transform and/or other processing of the signals sensed by the touch screen device including its screen circuitry and its audio circuitry).

In various embodiments, the inventive stylus is a powered, non-powered, active, or passive device. For example, it is contemplated that some embodiments of the stylus is specially designed to draw power (e.g., about half a Watt) from an audio output channel (and/or other channels) of a cable connected between the stylus and a host, for use by op amps or other circuit elements in the stylus. In operation, other embodiments of the stylus would not draw power from a host (or would draw no more than an insignificant amount of power from a host, e.g., no more than very small amounts of power unavoidably dissipated as heat due to resistance of circuit elements in the stylus).

In some embodiments, the invention is a stylus for a capacitive touch screen which is configured to mechanically stimulate the touch screen and to assert modal information to the touch screen by patterned disconnection of a capacitive load (either external to the stylus, e.g., provided by the body of a human gripping the stylus, or internal to the stylus) via purely mechanical means of winding or shaking. For example, the stylus is capable of being powered (e.g., re-charged) in response to a shaking, twisting, or general user motion by means of an internal mechanism that translates the mechanical energy into electrical energy (e.g., for recharging a battery local to the stylus, or for use directly by the stylus for its operation). The touch screen is configured to implement a method for recognizing such a stimulus pattern to select a modality of interaction with the stylus.

In some embodiments, the invention is a stylus which is configured to stimulate a capacitive touch screen mechanically and to communicate modal information to the touch screen (e.g., by patterned disconnection of circuitry within the stylus) via a wireless link (e.g., an RF link), where power consumed by the stylus during operation is derived from mechanical means local to the stylus (e.g., within the stylus), e.g., by shaking or twisting the body of the stylus. The touch screen is configured to implement a method for recognizing such a stimulus pattern to select a modality of interaction with the stylus.

In some embodiments, the invention is a stylus which is configured to stimulate a capacitive touch screen mechanically and to communicate (to the touch screen) stylus identification data that uniquely identifies the stylus (or a user thereof). The touch screen device is configured (e.g., includes a processor programmed with application software) to identify the stylus (or user) in response to the stylus identification data, e.g., so that the touch screen device can operate in different modes in response to input from each of multiple styli. For example, the touch screen device implements an annotation application that uses a unique identification of each stylus to identify a unique user and to capture and/or display the user's name and or other specific information that is tied to that user.

In some embodiments, the tip actuation signals from the stylus to the host device may be provided to the host device through, for example, the DOCK connector on a host device that provide power to the stylus from the host device (the DOCK connector is a docking connector that has multiple signals in it: audio, USB, RS232, etc). The tip actuation signals may also be provided through a USB connection (that is also may provide power to the stylus from the host device) through a USB cable. The tip actuation signal may be provided to the host device utilizing any data communications protocol (e.g., RS232, WiFi, BlueTooth, CAN, etc.); if it is a wireless protocol, then a stand-alone power source (e.g., battery) is needed. An aspect of the tip-to-touch disambiguation algorithm relies on a data communications means, either parallel or serial, that is capable of representing and transmitting the following events in at least one direction (from the stylus to the host device) in a timely manner:

TIP(n) depressed (sufficient actuation force applied)

TIP (n) released (insufficient actuation force applied)

wherein n represents the tip number.

In an embodiment, a system is provided having a capacitive touch screen device comprising a capacitive touch screen surface; and a controller that defines a touch screen event on the capacitive touch screen surface by the touch event having at least a threshold contact area value and at least a threshold change in local capacitance value; and a stylus comprising a tip with a conductive surface coupled to a capacitance, the tip of capacitance switchable from a first state (tip down) in which the tip coupled to the capacitance stimulates the capacitive touch screen surface to a second state (tip up) in which the tip does not stimulate the capacitive touch screen surface. This system is used to perform a method comprising (a) transmitting from the stylus to the capacitive touch screen device a signal associated with a transition in the stylus from the tip up state to the tip down state and assigning a time T1 to that signal; (b) on the capacitive touch screen device, gathering all touch event data, including touch events, if any, associated with contact between the stylus tip in the tip down state and the capacitive touch screen; (c) for gathered touch events that occurred within a predetermined time interval relative to T1, creating a collection of unclassified touch event data; and (d) processing the collected unclassified touch event data to differentiate touch events likely caused by movement of the stylus tip in the tip down state from touch events likely caused by touches of the capacitive touch screen objects other than the stylus.

In some embodiments, the invention is a capacitive touch screen device that is configured to recognize (e.g., includes a processor programmed to recognize) an operating mode of an embodiment of the inventive stylus in response to at least one signal indicative of the state of switching circuitry in the stylus, and in response to touch screen sensor data (i.e., data generated and processed conventionally in touch screen devices to calculate a centroid from an outline of an object's contact area on a touch screen) including by processing the touch screen sensor data in at least one of the following additional ways beyond the time window method ways: disambiguating movement of the stylus on the screen versus non-stylus strokes by predicting a future location of contact area of the stylus on the screen (e.g., by determining a vector established by the previous sequence of centroids (or other measures of the location) of each previous user strokes of the moving stylus assigned contact areas on the touch screen and establishing a probability that the tip generated stroke will be coincident with that vector by using a process of dead reckoning); determining velocity of each segment within the contact stroke on the screen and using a threshold to eliminate all strokes that contain segments that exceed a certain threshold velocity; determining acceleration of each segment within the contact stroke on the screen and establishing a probability that the stroke is intended or spurious using mathematical functions of acceleration; determining the acceleration between the end of the previously classified tip stroke and the beginning of the current stroke and establishing a probability that the stroke is intended or spurious using mathematical functions of acceleration; determining a measure of the location of currently active “palm” strokes classified by previous processing (e.g., by assuming all non-tip strokes must be palm strokes) and using the relative locations of these active palm strokes to create a probability that the unclassified stroke is intended or spurious using a mathematical function of the distance between said palm locations and the unclassified stroke. In the absence of prior information (i.e., first touch, or a touch that occurs after a certain time threshold, and no currently active palm location), the method establishes a probability that each stroke is generated by a stylus or palm based on a function (e.g., median, mean or median absolute deviation from the median) of the length of segments in the stroke. These techniques alone or in combination can allow (or help to allow) the touch screen device to disambiguate between user-intended stylus touches on the screen and non-intended or spurious “palm” touches.

### BRIEF DESCRIPTION OF THE DRAWINGS

FIG. 1 is a perspective view of an embodiment of the stylus in use with a capacitive touch screen device.

FIG. 2 is a side cross-sectional view of stylus 1 of FIG. 1, showing felted tip 11 of the stylus mounted on post 9 which extends through tip holder 7 at the distal end of shaft 5 of the stylus.

FIG. 3 is a perspective view of conductive, felted stylus tips 11, 21, and 22, each useful as an element of an embodiment of the stylus and each having a different shape. Each of tips 11, 21, and 22 is formed with a hole (a respective one of holes 11A, 21A, and 22A, as shown) extending partially through the tip for receiving the distal end of post 9.

FIG. 4 is a perspective view of a detail of metal supporting rod 9 (of FIG. 2) with hooks 10 for retention of felted tip 11.

FIG. 5 is a perspective view of a spherical conductive felted stylus tip with a spherical shape, and a side cross-sectional view of the stylus tip mounted in direct contact with the shaft of an embodiment of the stylus. The tip is held to the shaft by friction or by an adhesive.

FIG. 6 is a perspective view of another conductive felted stylus tip of a hemispherical shape, and a side cross-sectional view of the stylus tip mounted in direct contact with the shaft of an embodiment of the stylus. The tip is held to the shaft by friction or by an adhesive.

FIG. 7 is a perspective view of another conductive felted stylus tip of a bullet shape, and a side cross-sectional view of the stylus tip mounted in direct contact with the shaft of an embodiment of the stylus. The tip is held to the shaft by friction or by an adhesive.

FIG. 8 is a perspective view of an embodiment of the stylus (having conductive stylus tips at both ends) in use with a capacitive touch screen device.

FIG. 9 is a simplified side cross-sectional view of an embodiment of the stylus having conductive stylus tips at both ends of its shaft 46, with a circuit diagram of passive switched circuitry within shaft 46. Stylus 45 of FIG. 9 is coupled by a conventional audio cable 49 to capacitive touch screen device 40 (which includes touch screen 42 and processor 41).

FIG. 10 is a block diagram of elements of an embodiment of the stylus, coupled with elements of a capacitive touch screen device.

FIG. 11 is a flow chart of steps performed in operation of an embodiment of the stylus and a capacitive touch screen device.

FIG. 12 is another flow chart of steps performed in operation of an embodiment of the stylus and a capacitive touch screen device.

FIG. 13 is a state diagram for a finite state machine diagram for classifying strokes into FINGER, TIP, or PALM strokes representative of an embodiment of the stylus and a capacitive touch screen.

### DETAILED DESCRIPTION OF PREFERRED EMBODIMENTS

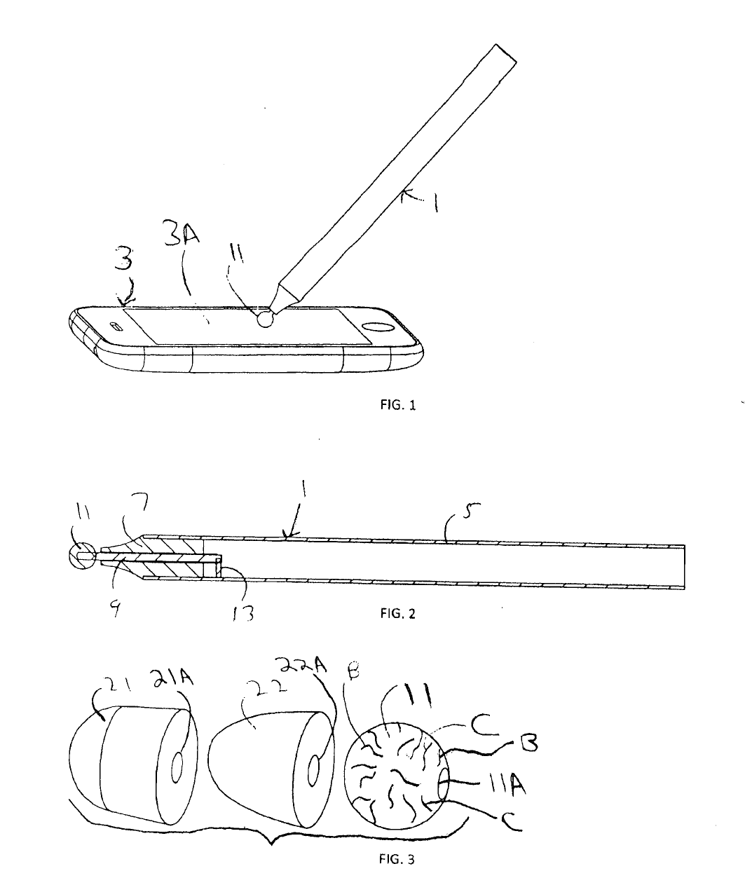

Embodiments of the stylus that include a felted tip will be described with reference to FIGS. 1-7. Other embodiments of the stylus that include at least one felted tip and switched circuitry, and systems including a touch screen device and such an embodiment of the stylus, will be described with reference to FIGS. 8-12.

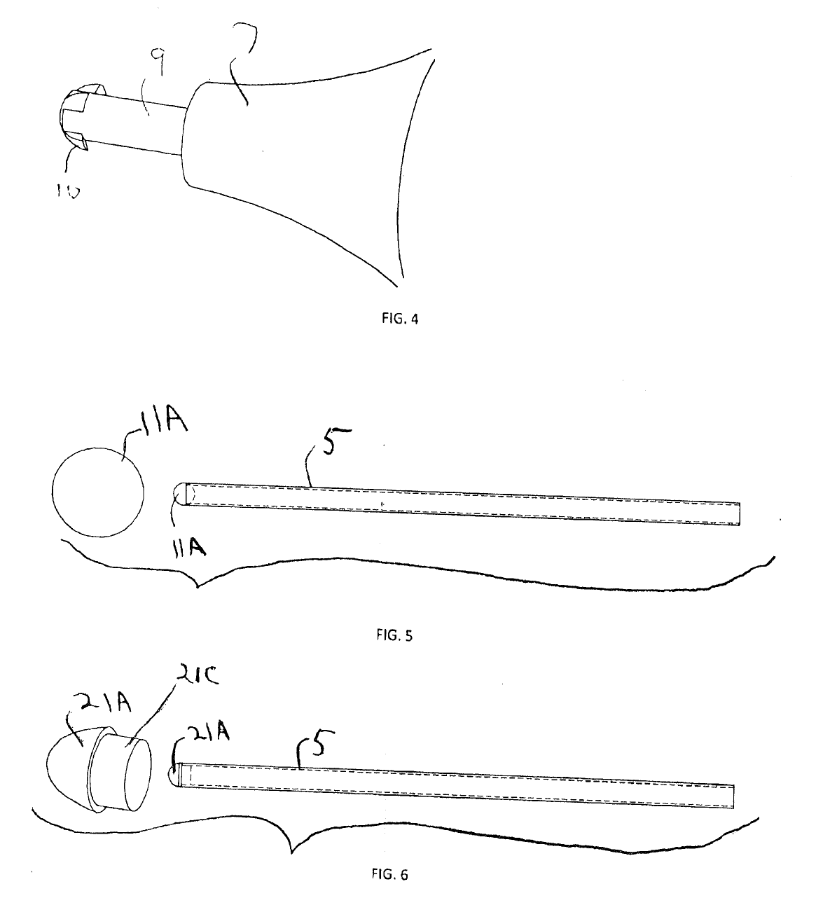

In a first class of embodiments, a stylus is provided for input to a capacitive touch screen. The stylus has a tip comprising (e.g., consisting of) conductive felt (e.g., felted tip 11 of FIG. 1, or felted tip 21 or 22 of FIG. 3) which provides a deformable conductive surface for contacting a touch screen (with a sufficiently large contact area to allow the touch screen to recognize a touch by the tip), and is capable of being moved in contact with the touch screen with less than an undesirable amount of friction (between the tip and a touch screen surface in contact therewith). The tip comprises first fibers (which are sometime referred to herein as “base” fibers, and are typically non-conductive) and conductive fibers, and is produced by felting the base fibers with the conductive fibers using the fiber material technique commonly known as felting. For example, felted tip 11 of FIG. 1 (better shown in FIG. 3) has base fibers B felted with conductive fibers C. The base fibers are selected to be conducive to felting (i.e., to have properties at the microscopic level that allow them to bond and tangle with one another in the presence of water), to have sufficient softness, flexibility, non-abrasiveness and low friction to produce sufficiently low friction when used (after being felted) as a capacitive touch screen stylus tip, and preferably to have low cost. During the felting process, the base fibers capture the conductive fibers and form a spherical, hemispherical or bullet-like felt object (or a felt object of other shape) that is semi-rigid (in the sense in the sense that it retains its shape unless and until it is deformed by forcing it against a touch screen or other object), and can be mounted to a distal end of a support to form a stylus. In use of the stylus, the felt object functions as a stylus tip that couples a sufficient capacitance to a touch screen, at a contact region on the screen of sufficient area, to allow recognition of a touch by the tip. In an embodiment, the tip by itself does not have sufficient capacitance to allow recognition of a touch by the tip.

As shown in FIG. 1, stylus 1 is an embodiment of the stylus which includes felted tip with a conductive surface 11. Tip 11 is in contact with screen 3A of capacitive touch screen device 3. As best shown in FIG. 2, felted tip 11 is mounted on conductive post 9 which extends through tip holder 7 at the distal end of shaft 5 of stylus 1. Post 9 has hooks 10 (best shown in FIG. 4) for retaining the tip to the rest of the stylus, and is a conductive member (e.g., a metal rod or tube) that protrudes distally from tip holder 7. Shaft 5 is conductive and hollow, and short conductive wire 13 connects post 9 to conductive shaft 5. Alternatively, hooked supporting rod 9 is replaced by a hookless metal rod with adhesive material at its distal end to hold felted tip 11 (or another embodiment of the felt tip) in place at an end of the stylus.

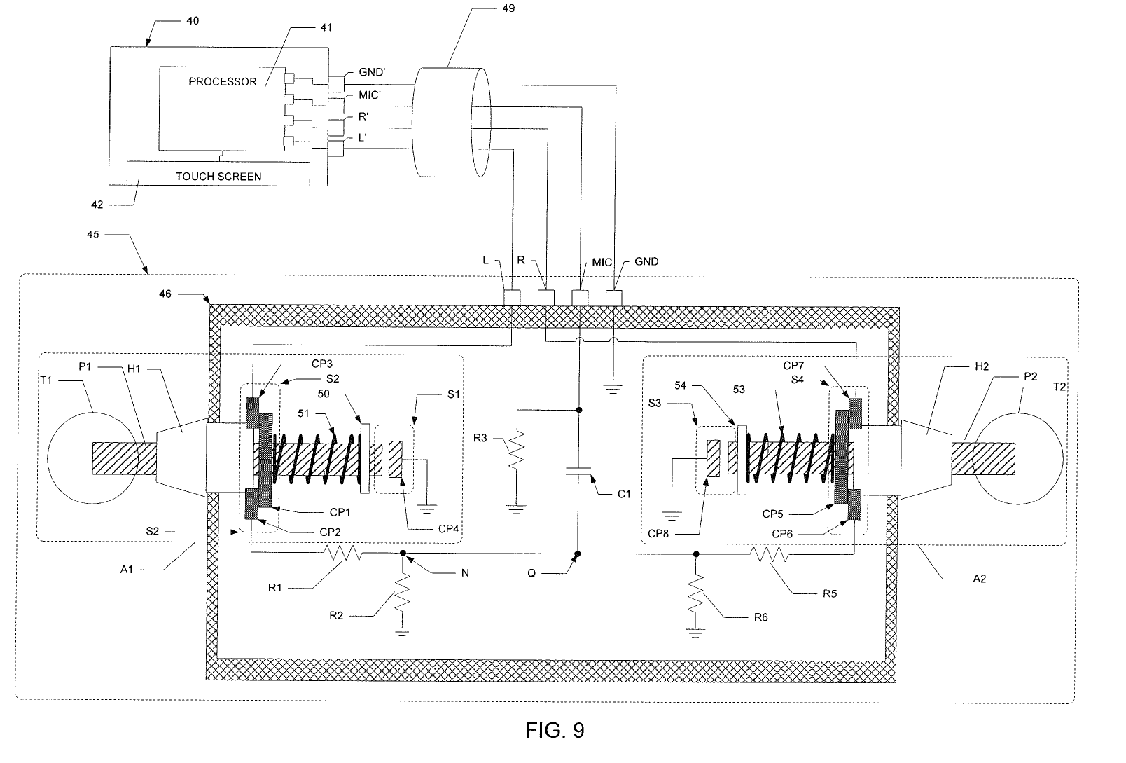

In variations on the FIG. 2 embodiment, post 9 is not coupled at all times to shaft 5. Instead, post 9 is configured to engage a switch (e.g., switch S1 of FIG. 9) of switched circuitry in the stylus, said switch being coupled to shaft 5 (or to a capacitance internal or external to the stylus), and post 9 is spring-biased to keep the switch in a normally open state, and is movable (in response to felted tip 11 being pressed against a touch screen or other object) to close the switch to couple felted tip 11 to shaft 5 (or to the internal or external capacitance). In the latter case, post 9 can be considered to be an element of the switch, so that the switch is coupled to tip 11 and is either open or closed depending on whether at least a threshold force is exerted (e.g., by screen 3A of touch screen device 3) on tip 11.

In some embodiments, the undeformed shape of a conductive, felted tip of the stylus is hemispherical (i.e., its distal surface which contacts a touch screen, when it is mounted in a stylus, is hemispherical), spherical or bullet-like. In other embodiments, its distal surface (which contacts a touch screen) is a truncated cone or a three-dimensional parabloid.

FIG. 3 is a perspective view of felted stylus tips 11, 21, and 22, each useful as an element of an embodiment of the stylus and each having a different shape. The distal surface of tip 21 is hemispherical, and the distal surface of tip 22 is a three-dimensional paraboloid. Felted tip 11 is shown to comprise base fibers B felted with conductive fibers C. Each of tips 11, 21, and 22 is formed with a hole (a respective one of holes 11A, 21A, and 22A, as shown) extending partially through the tip for receiving the distal end of post 9. Alternatively, each of the tips is not preformed with such a hole, and the post is simply pushed into the tip during assembly of the apparatus.

FIG. 5 is a perspective view of a spherical, conductive, felted stylus tip 11A, and a side cross-sectional view of tip 11A mounted in direct contact with a distal end of shaft 5 of an embodiment of the stylus. Tip 11A is held to shaft 5 by friction or by an adhesive.

FIG. 6 is a perspective view of another conductive felted stylus tip (21A) and a side cross-sectional view of tip 21A mounted in direct contact with a distal end of shaft 5 of an embodiment of the stylus. Tip 21A's cylindrical proximal end 21C is held to shaft 5 by friction, or tip 21A is held to shaft 5 by an adhesive. The distal surface of tip 21A is a three-dimensional parabloid.

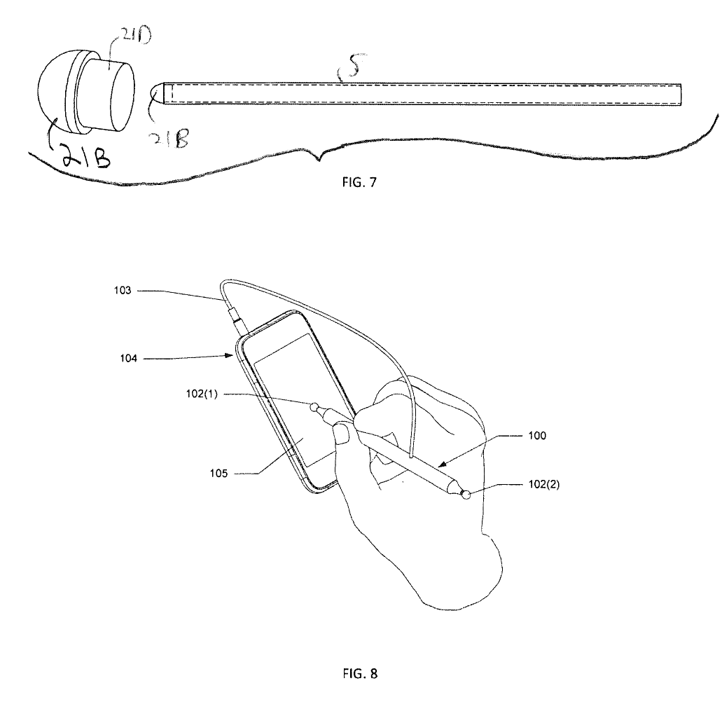

FIG. 7 is a perspective view of another conductive felted stylus tip (21B) and a side cross-sectional view of tip 21B mounted in direct contact with a distal end of shaft 5 of an embodiment of the stylus. Tip 21B's cylindrical proximal end 21D is held to shaft 5 by friction, or tip 21B is held to shaft 5 by an adhesive. The distal surface of tip 21B is hemispherical.

The technique for manufacturing typical embodiments of the stylus tip starts with a base fiber (preferably a common, inexpensive base fiber) that is already conducive to felting. Wool or any other fiber that has scales which interlock at the microscopic level during a felting process is suitable as a base fiber in many embodiments. Interspersing this base fibers with conductive fibers, which typically do not have the same microscopic characteristics necessary for felting, allows the base fibers to lock and hold the strands of the conductive fibers. The felting should produce a semi-rigid, felt object having shape suitable for use as the tip of a capacitive touch screen stylus (e.g., spherical, hemispherical or bullet-like shape), and size suitable for affixing to the end of a capacitive touch screen stylus body (e.g., a conductive rod or tube, or a non-conductive tube including or coupled to a capacitance, where the capacitance is connected by a conductor to the felt object in at least one operating mode). When the stylus has a conductive body, the conductive body (and optionally a conductive structure between the felt tip and the conductive body) couples with the human hand and therefore provides a low impedance path between the conductive felted tip and the human body, allowing a capacitive touch screen to properly calculate a centroid based on the area of contact between the tip and the screen. By using base fibers of sufficiently low friction (when felted) in the tip, the coefficient of friction of the felted tip against the glass surface of a capacitive touch screen is significantly low to allow for a natural (pen-like) feel of the stylus as the tip slides on (or is touched against) the screen.

The blending percentage of the conductive fibers and diameter of the felted tip can be chosen to be optimal for the intended use of the capacitive touch screen stylus. The minimum capacitive load to be coupled via the tip, and the minimum two-dimensional contact area of the tip with the screen, will depend on the host device with which the stylus is used. The conductive fibers can be any fibers that inherently (or are modified to) have electrical resistivity preferably less than 10,000 ohms-cm (and not more than on the order of 10,000,000 ohms-cm). To produce the tip, the base and conductive fibers are mixed in a ratio sufficient for the tip to have sufficient conductivity to provide the electrical coupling necessary for a stylus including the tip to stimulate a capacitive touch screen. The tip's conductive fibers (rather than any other element of the tip) provide the tip's conductivity that is required for its intended use (e.g., the conductive tip is normally used when dry, but even if it happens to be used when wet with a conductive liquid or contaminated with a conductive substance, it does not rely on the liquid's or the contaminant's conductivity to be useful as a capacitive touch screen stylus tip).

Examples of conductive fibers suitable in typical embodiments include but are not limited to carbon fibers, fibers coated with metal, and fibers coated with carbon. The exemplary conductive fibers have low-friction and non-abrasiveness properties similar to those of typical base fibers with which they are felted. Thus, when felted with the base fibers to produce a stylus tip, the tip can have acceptably low friction and non-abrasiveness. In contrast, metal wires are typically more abrasive than the exemplary conductive fibers. Thus, a tip consisting (or including a significant quantity) of metal wires would typically abrade the surface of a touch screen during use.

In some embodiments, the tip comprises 1/3 conductive fibers and 2/3 base fibers. The conductive fibers may comprise Jarden Materials RESISTAT® TYPE F9216, merge L040, nylon electrically conductive with carbon suffused onto the fiber surface, cut into 4 inch lengths and having a resistance of 4000 ohm/cm. The base fibers may comprise 18.5 micron Merino wool fibers. In this instance, 0.06 grams total material felts into a ball approximately 0.250″ in diameter The weight is approximately 0.05 grams per piece. A 1/16″ diameter brass rod approximately 1.85″ long may be utilized as support structure for the tip. The tip may be constructed by mixing the wool base fiber with the conductive fiber using a drum carder to achieve uniform mixing. The material is weighed and separated into 0.06 gram amounts. Balls are spun in a toroidal shaped grooved mold with a standard hand drill @ 1000 RPM under hot tap water utilizing Dr. Bronner's soap as a lubricant. The balls are then left to air dry. The air dried balls are then drilled 50% through and the brass rod is inserted into the resulting hole and affixed utilizing standard 5 minute epoxy.

In some embodiments, the above-mentioned conductive and base fibers are mixed according to the 1/3 conductive fiber, 2/3 wool fiber ratio. The mixture strands are then felted into a cord by water and soap and hand rolling and stretching the cord to achieve a uniform cylinder with a circular cross-section. The cylindrical diameter may be ⅛″. The strands are then cut into desired lengths, e.g. 0.25″. The brass rod is then inserted into the center of one circular face of the cylinder and epoxied into place utilizing, for example, standard 5 minute epoxy. The other circular face of the cylinder may then be trimmed to provide a hemispherical end to the cylinder to make the tip structure “bullet” shaped.

The blending percent also depends upon the shape of the final felted product as well as the means by which it is felted or the fibers are otherwise combined prior to needle felting or wet felting with water. For example, when the fibers are organized such as through knitting, crocheting, braiding, knotting, weaving and/or spinning into multiply plies, the conductive properties are reduced, thereby requiring a higher percentage of conductive fiber in the felting mix. When using a mixture of 50% conductive fibers and 50% base fibers (by weight), one can knit an I-cord (a spiral knit tube also called idiot cord) to make a tip with the necessary conductive properties. By knitting the I-cord before needle felting or wet felting, the fibers are pre-tangled before felting, resulting in a tip that holds its shape over use with time. When a tip is cut from either end of a felted I-cord, the tip has a bullet shape with a rounded end that is finished and will not splay, unravel, or wear as quickly with use as a tip that is made from a cut end of yarn that has been needle felted and wet felted.

In other embodiments, wool roving is spun into a single ply of yarn, which is needle felted by poking repeatedly with barbed felting needles on top of a foam base. Then, the needle felting yarn is wet felted by rolling the yarn back and forth under hot tap water utilizing Dr. Bronner's soap as lubricant. The yarn is then left to air dry and cut into 11 mm segments. One end of each segment is further cut to achieve a rounded, hemispherical tip. The tips are drilled 0.25 inches through their length, and the brass rod is inserted into the resulting hole and affixed utilizing standard epoxy.

In a class of embodiments, the invention is a stylus for providing input to a capacitive touch screen, said stylus comprising:

a shaft (e.g., conductive shaft 5 of FIG. 2, or non-conductive shaft 46 of FIG. 9 to be described below); and

at least one felted tip (e.g., tip 11 of FIG. 2, or tips T1 and T2 of FIG. 9) supported by the shaft, wherein each said felted tip is electrically conductive and deformable, and includes base fibers and conductive fibers felted with the base fibers.

Typically, the felted tip is semi-rigid (in the sense that it retains its shape unless and until it is deformed by forcing it against a touch screen or other object), has been produced by a process including a felting step, and the base fibers are structured such that the felting step results in felted material having interlocking bonds and/or tangles between the base fibers and the conductive fibers that provide the semi-rigidity. Typically, the felted tip is sufficiently rigid to be functional as a touch screen stylus tip without any internal structure being inserted within it to provide support and/or rigidity The fibers are randomly distributed throughout the felt with regions of higher density and other regions of lower density of conductive fibers. The blending is sufficient so that the density of the conductive fibers throughout the tip is sufficient to allow for the required conductivity, and the wool is distributed sufficiently to hold the conductive fibers together after felting.

In some embodiments, however, the felted tip comprises a conductive, felted outer layer, and a conductive supporting structure within the outer layer. In typical embodiments, the tip is mounted to a conductive post or wire (or other conductive structure) such that the tip and conductive structure are translatable together as a unit relative to the rest of the stylus. Such conductive structure may extend into the tip. The size and shape of the felted tip (sometimes referred to as a “contact” tip) are such that the felted tip at an end of a stylus can contact the touch screen (in an undeformed state and/or a deformed state resulting from deformation in response to being forced against the screen) at a coupling area sufficient to stimulate the touch screen (e.g., detection circuitry in the touch screen) to recognize a distinct touch by the stylus.

In some embodiments, the shaft (or the shaft and a conductive structure coupled thereto) provides a low impedance path (e.g., the path through shaft 5, wire 13, and post 9 of FIG. 2) capable of coupling the capacitance, of the hand (or body) of a user who grips the stylus, via the felted tip, to a touch screen (when the felted tip is in contact with the touch screen). In other embodiments, the stylus includes at least one switch between the felted tip and the shaft. When the switch is closed the stylus provides a low impedance path capable of coupling the capacitance, of the hand (or body) of a user who grips the stylus, via the felted tip, to a touch screen (when the felted tip is in contact with the touch screen). When the switch is open, the stylus does not couple the capacitance of the hand (or body) of a user who grips the stylus via the felted tip to a touch screen and the touch screen thus cannot register (recognize) a touch of the felted tip on the touch screen.

In other embodiments, the stylus includes switched circuitry (including at least one switch coupled directly or indirectly to an internal capacitance) between the felted tip and the shaft. When the switch is closed the stylus provides a low impedance path capable of coupling the capacitance to a touch screen (when the felted tip is in contact with the touch screen). When the switch is open, the stylus does not couple the capacitance via the felted tip to a touch screen and the touch screen thus cannot register (recognize) a touch of the felted tip on the touch screen.

In other embodiments, the stylus includes switched circuitry (including at least one switch) and a capacitance (e.g., the capacitance of a cable or the combined capacitance in conjunction with another object coupled to the stylus through the cable) is coupled to the switched circuitry. When the switch (e.g., switch S2 or S4 of FIG. 9) is closed, the stylus provides a low impedance path (e.g., the path through tip T1 and switch S2 and audio cable 49, or tip T2 and switch S4 and audio cable 49, of FIG. 9) capable of coupling the capacitance (e.g., the capacitance of cable 49) to a touch screen when the felted tip is in contact with the touch screen. When the switch is open, the stylus does not couple the capacitance via the felted tip to a touch screen and the touch screen thus cannot register (recognize) a touch of the felted tip on the touch screen.

We next describe a second class of embodiments and a third class of embodiments of the invention with reference to FIGS. 8, 9, 10, 11, and 12.

FIG. 8 shows an embodiment of the stylus (100) that has two conductive tips 102(1) and 102(2) at opposite distal ends of the stylus. Each of conductive tips 102(1) and 102(2) is preferably a conductive felted tip, and each provides a contact surface for engagement with capacitive touch screen 105 of host device 104. Stylus 100 also includes switched circuitry (not shown) coupled to tips 102(1) and 102(2) and including a stylus audio port set (including left and right channel audio output ports, a microphone input port, and a ground port) coupled to one end of audio cable 103. The other end of cable 103 is coupled to a conventional audio port set (including left and right channel audio output ports, a microphone input port, and a ground port) of host device 104. Cable 103 is a conventional audio cable which includes conductors that implement left and right audio output channels (conventionally used for driving left and right transducers of audio headphones), a microphone input channel, and system ground. Host device 104 can be any capacitive touch screen device having an audio port set (and audio circuitry coupled thereto).

Many conventional devices that include capacitive touch screens are also capable of producing one or two output audio signals capable of powering headphones (e.g., left and right channels of a stereo audio signal asserted from device 104 via cable 103 to a pair of headphones). These signals are typically intended for the left and right ear transducers of a pair of headphones, but are asserted to switched circuitry of a touch screen stylus in accordance with some embodiments of the present invention. Many conventional touch screen devices are also typically configured to receive a microphone input (e.g., a microphone input signal asserted from a microphone via cable 103 to device 104). Some embodiments of the stylus utilize these existing signal paths and a set of contact actuated switches and/or sensors with optional filters to send signals to a host device (e.g., to a processor in a host device that runs application software). Typically, the host sends pre-defined signal patterns over the audio output channels, and processes the signals received back from the stylus in response (over the microphone input channel) to determine a mode of interaction with the stylus (e.g., including by determining contact and/or force exerted by a touch screen on a first tip (e.g., tip 102(1) of FIG. 8) of the stylus, contact and/or force exerted by a touch screen on a second tip (e.g., tip 102(2) of FIG. 8) of the stylus, no contact by a stylus tip, and other modal information that may be encoded via switches or sensors of switching circuitry within the stylus).

FIG. 9 is a simplified side cross-sectional view of stylus 45 which is another embodiment of the stylus, shown coupled by conventional audio cable 49 to a capacitive touch screen device 40. Device 40 includes capacitive touch screen 42 (which can have conventional design) and processor 41 connected to receive signals from screen 42 indicative of touches and/or strokes on screen 42. The body (shaft) 46 of stylus 45 is non-conductive and hollow. Stylus 45 also includes passive switched circuitry mounted to shaft 46, and FIG. 9 includes a circuit diagram of the passive switched circuitry.

The passive switched circuitry of stylus 45 includes a stylus port set that can be (and is, as shown in FIG. 9) coupled to an end of cable 49. The stylus port set includes microphone output port MIC, left channel audio input port L, right channel audio input port R, and ground port GND. Ports MIC, L, R, and GND are coupled respectively to microphone signal, left audio channel, right audio channel, and ground conductors of cable 49. The conductors of cable 49 are enclosed within an insulator. The GND wire alone, or when connected to the host device, may provide sufficient capacitance when coupled to tip T1 (or T2) of stylus 45 to allow conventional capacitive touch screen elements of device 40 to recognize a touch of tip T1 (OR T2) on screen 42.

Device 40 includes a stylus port set coupled to the other end of cable 49, and including microphone input port MIC′, left channel audio output port L′, right channel audio output port R′, and a ground port GND′.

Stylus 45 includes conductive tip T1 (preferably an embodiment of the felted tip) mounted on conductive post P1 which extends through (and is translatable relative to) tip holder H1 at the left end of shaft 46. Spring 51 is compressed between the edge of the printed circuit board, 50, and the right end surface of the contact point CP1 which is rigidly attached and translates with conductive post P1. Holder H1 centers post P1 and tip T1 within shaft 46 with freedom to translate inward (to the right in FIG. 9) toward shaft 46 when pressed against screen 42 of device 40. Contact point CP1 is electrically isolated from conductive post P1. Contact points CP2 and CP3 show the remaining components necessary for S2 to function as a switch. CP2 and CP3 are rigidly attached to holder H1 and provide the completion of the circuit when CP1 is in simultaneous contact with CP2 and CP3. Tip T1, conductive post P1, holder H1, contact points CP1, CP2, CP3 and spring 51 comprise assembly A1.

Stylus 45 also includes conductive tip T2 (preferably an embodiment of the felted tip) which is shown as part of assembly A2. A2 an identical assembly to assembly A1 except the translation motion of P2 moves to the left in FIG. 9 when pressed against screen 42 of device 40.

In typical use, tip T1 is used to “write” on screen 42 by making strokes (recognized by processor 41 as touches on screen 42) which compress spring 51 to move post P1 so as to open a normally closed switch S2 (comprised of contact points CP1, CP2, and CP3) and then (within a predetermined time window) close switch S1. In typical use, tip T2 is used to “erase” a mark (that has previously been caused to be displayed) on screen 42 by making strokes (recognized by processor 41 as touches on screen 42) which compress spring 53 to move post P2 so as to open a normally closed switch S4 and then (within a predetermined time window) close switch S3.

The elements of the passive switched circuitry that are mounted within shaft 46 include normally closed switch S2 connected to audio input L on one pole of S2 and resistor R1 on the other pole of S2. Resistors R1 and R2 serve as a voltage divider attenuator between S1 and ground. Viewed in isolation from the rest of the circuit (i.e. only considering the interaction of L, R1, R2, and S2) node N represents either no signal (if S2 is open) or the attenuated output of the L signal (if S2 is closed). The passive switched circuitry also includes resistors R5, R6, switch S4 and audio channel R. These circuits mirror the functions of R1, R2, S2 for the Right audio channel combined with the actuation of T2.

In operation of the FIG. 9 system, processor 41 asserts audio signals to stylus 45 via the left and right audio channels of cable 49. The audio signal asserted from processor 41 to port L′ of host 40 may comprise frequency components in a first band. The audio signal asserted from processor 41 to port R′ of host 40 may comprise frequency components in a second band (distinct from the first frequency band). The audio signal asserted at port L′ can propagate through cable 49 to port L of stylus 45 and either be returned (looped back through the loop including resistor R1, switch S2, capacitor C1, and the microphone, MIC, channel of cable 49) to host 40, or not returned to the host, depending on the state of switch S2 in stylus 45. The audio signal asserted at port R′ can propagate through cable 49 to port R of stylus 45 and either be returned (looped back through the loop including resistor R5, switch S4, capacitor C1 and the microphone channel of cable 49) to host 40, or not returned to the host, depending on the state of switch S4. The different frequency content of the signal returned through each loop allows processor 41 to distinguish between an event in which switch S2 undergoes a transition between open and closed states, and an event in which switch S4 undergoes a transition between open and closed states.

The resistances of resistors R1 and R2 should be selected so that the voltage across resistor R2 (in operation of stylus 45 with a left channel audio signal of typical voltage asserted from device 40 via cable 49 to the loop comprising resistors R1 and R2, capacitor C1, and switch S2) is suitable (and no more than desirable) for asserting back to cable 49 a return signal of suitable amplitude (in response to the left channel audio signal) for processing by device 40 to recognize intended touches on screen 42 by tip T1. Similarly, the resistances of resistors R5 and R6 should be selected so that the voltage across resistor R6 (in operation of stylus 45 with a right channel audio signal of typical voltage asserted from device 40 via cable 49 to the loop comprising resistors R5 and R6, capacitor C1 and switch S4) is suitable (and no more than desirable) for asserting back to cable 49 a return signal of suitable amplitude (in response to the right channel audio signal) for processing by device 40 to recognize intended touches on screen 42 by tip T2.

The resistor R3 connected to GND may be required by the host device to inform it that a microphone input is available. In host devices that do not require this specific stimulus, R3 may be omitted. The resistance of R3 is chosen based on the specifications of the host device and may therefore vary.

The capacitor C1 is used to achieve the AC coupling of the audio signal and to allow for the proper operation of resistor R3 (if required by the host device 40). The value of C1 is chosen in relationship to the frequencies bands that are sent by host 40 to the stylus 45. Capacitor C1 serves as a high pass filter and will attenuate lower frequencies. Node Q indicates the mixing point of the switched and attenuated signals from the L and R channels before AC coupling in capacitor C1.

The passive switched circuitry of stylus 45 also includes normally open switch S1 between post P1 and the ground port GND, and normally open switch S3 between post P2 and the ground port GND. Switch S2, which comprises the right edge of post P1 and the printed circuit board edge contact point CP4, is open when post P1 is in its normal state (biased toward the left of FIG. 9 by spring 51), and is positioned relative to post P1 so as to enter its closed state when P1 is pushed inward (to the right of FIG. 9) into engagement with CP3 in a mode of operation in which tip T1 is pressed against screen 42. Switches S2 and S1 are positioned relative to each other (and relative to post P1) such that when tip T1 is pressed against screen 42 with sufficient force (and with typical speed) by a user, contact points CP2 and CP3 translate (with shaft 46) to the left causing contact point CP1 (rigidly attached to post P1) to move out of engagement with CP2 and CP3 (thereby opening switch S2), and as shaft 46 (with rigid attachment to contact point CP4 of switch S1) continues to translate to the left, CP4 engages the edge of post P1 (within a predetermined time window after the opening of switch S2) to close switch S2. The closing of switch S1 couples the capacitive load presented by cable 49 (through port GND and post P1 and tip T1) to screen 42, thus allowing processor 41 to recognize a touch of tip T1 against the screen. Processor 41 is programmed to recognize a touch of tip T1 against screen 42 only in response to recognizing that the loop comprising left input port L, resistor R1, switch S1, resistors R3 and R4, and output port MIC has opened (in response to opening of switch S1, which in turn occurs only when at least a threshold force is exerted on tip T1 to open the switch S1) and then, within the predetermined time window, the conventional capacitive touch screen sensing subsystem of screen 42 senses that tip T1 is in contact with screen 42 (the latter event can occur only when switch S2 closes to couple the capacitive load of cable 49's GND wire (which may include the capacitance of host device 40) to screen 42 while tip T1 is in contact with screen 42). Assembly A2 is comprised of switches S3, S4, spring 53, holder H2, post P2, and tip T2 and has exactly the same function as assembly A1 with the exception that the translation of shaft 46 is toward the right of the page.

Post P1 and “switch” S1 of FIG. 9 together constitute a switch, said switch being coupled to tip T1. Element S1 of this switch can simply be a node that is biased in a first position in so there is no contact with any stylus circuitry and can be moved by post P1 (as post P1 advances to the right in FIG. 9) into electrical contact with contact point CP3 and therefore be connected to GND. Also, post P2 and “switch” S3 of FIG. 9 together constitute a switch, said switch being coupled to tip T2. Element S3 of this latter switch can simply be a node that is biased in a first position in contact with node M and can be moved by post P2 (as post P2 advances to the left in FIG. 9) out of electrical contact with node M.

In some embodiments, tip actuations that do not correspond to touch strokes (e.g. the user provides sufficient actuation force to T1 or T2 or in combination on surfaces other than the touch screen 42; herein referred to as “non-touch actuations”), the host software can be written to interpret these events to indicate other types of user interactions. In some embodiments tip T2 non-touch actuations may be interpreted as “undo last stroke”. Likewise T1 non-touch actuations can be interpreted as “redo last stroke”. In other embodiments, such as when software on host is serving to forward user interactions through host 40 to a networked computer other than host 40, T1 non-touch actuations could be assigned to “left mouse click/release” and T2 non-touch actuations could be assigned to “right mouse click/release” events to be forwarded to the networked computer.

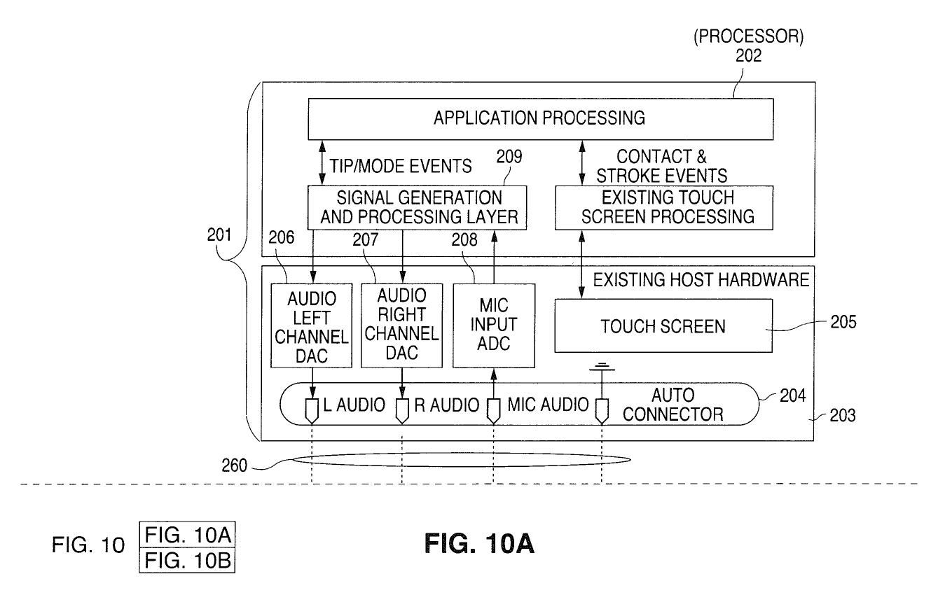

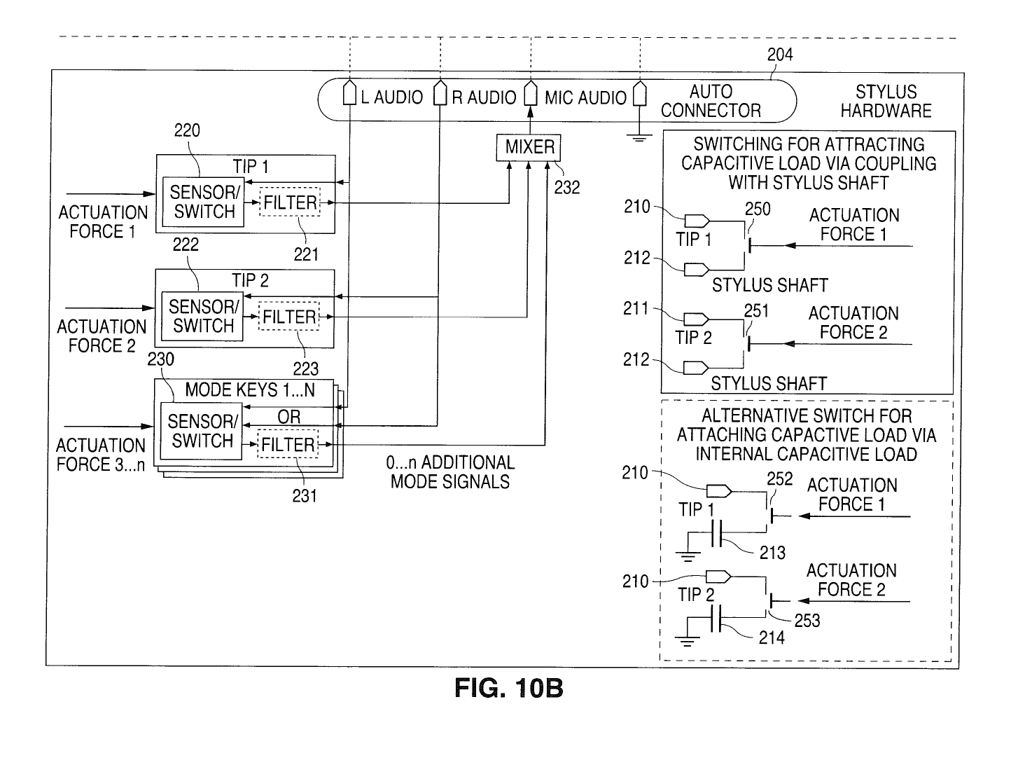

FIG. 10 is a block diagram of elements of an embodiment of the system including stylus 200, capacitive touch screen device 201, and audio cable 260 coupled between stylus 200 and device 201. Device 201 includes stylus audio port set 240 (coupled to cable 260). Device 201 includes host audio port set 204 (coupled to cable 260), a conventional capacitive touch screen 205, and processing circuitry coupled to touch screen 105 and port set 204. The processing circuitry (referred to herein as a processor) includes a programmed processor 202, analog-to-digital conversion circuitry 208 coupled and configured to generate (and assert to processor 202) digital audio data in response to an audio signal received at a microphone input port (labeled “Mic Audio”) of port set 204, left channel digital-to-analog conversion circuitry 206 coupled and configured to assert an analog audio signal to a left channel audio (“L audio”) output port of port set 204 in response to audio data from processor 202 (or a memory associated with processor 202), and right channel digital-to-analog conversion circuitry 207 coupled and configured to assert an analog audio signal to a right channel audio (“R audio”) output port of port set 204 in response to audio data from processor 202 (or a memory associated with processor 202).

Stylus 200 includes conductive shaft 212, conductive, felted tip 210 at one end of the shaft, and another conductive, felted tip 211 at the other end of the shaft. Stylus 200 also includes passive switched circuitry (for indicating stylus mode), including switch 250 (coupled between tip 210 and shaft 212), switch 251 (coupled between tip 211 and shaft 212), sensor 220 (which can be implemented as a simple switch having two states or as a sensor having more than two states) and optionally also filter 221 connected between the left channel (L) audio input port (of port set 24) and an input of mixer 232, sensor 222 (which can be implemented as a simple switch having two states or as a sensor having more than two states) and optionally also filter 223 connected between the right channel (R) audio input port (of port set 24) and another input of mixer 232, and at least one sensor 230 (which can be implemented as a simple switch having two states or as a sensor having more than two states) and optionally also filter 231 connected between one or both of the L and R audio input ports (of port set 24) and at least one other input of mixer 232. Mixer 232 combines the outputs of sensor 220 (or filter 221), sensor 222 (or filter 223), and sensor 230 (or filter 231), and asserts the combined output to the Microphone output port (of port set 24). The passive switched circuitry is coupled to the processor of device 201 via port set 240 and audio cable 260.

Alternatively, switches 250 and 251 are omitted from stylus 200, and replaced by switch 252 (coupled between tip 210 and capacitance 213) and switch 253 (coupled between tip 211 and capacitance 214). Capacitances 213 and 214 may be internal to stylus 200 or external to (but coupled to) to stylus 200.

The switched circuitry of stylus 200 (implemented to include elements 213, 214, 252, and 253) has a state (e.g., determined by switch 252 or 253, each actuatable by force of contact of a tip of the stylus with any surface, e.g., a touch screen) in which it couples a capacitive load (213 or 214) internal to the stylus to a tip of the stylus. The switched circuitry of stylus 200 (implemented to include elements 250 and 251 and a conductive shaft 212) has a state (e.g., determined by switch 250 or 251, each actuatable by force of contact of a tip of the stylus with any surface) in which it couples to a tip of the stylus an external capacitive load (e.g., connects the tip to conductive shaft 212 and thereby to the capacitance of a user's hand gripping the shaft 212).

The switched circuitry of stylus 200 also includes a switch or sensor (element 220) actuatable by a tip of the stylus to close or open a circuit path between a first audio output channel (of audio cable 260) and a microphone input channel (of cable 260) to allow routing of a signal (from host 201) back to the host either at full strength or attenuated in response (e.g., proportionally) to the contact force on the tip. The switched circuitry of stylus 200 also includes switch or sensor (element 222) actuatable by a second tip of the stylus to close or open a circuit path between a second audio output channel (of audio cable 260) and a microphone input channel (of cable 260) to allow routing of a signal (from the host) back to the host either at full strength or attenuated in response (e.g., proportionally) to the contact force on the second tip.

The switched circuitry of stylus 200 also includes at least one element 230. Each element 230 is a switch (optionally with a filter 231 connected in series therewith), or a variable circuit element (e.g., a sensor or source), optionally with a filter 231 connected in series therewith, whose state is determined by sensor input (e.g., force, slider position, or position of a rotatable annular ring of stylus 200). For example, element 230 can be implemented as a sensor which is a band pass filter, where the passband of such sensor is indicative of a parameter (e.g., width or color of a stroke by stylus 200 on screen 205) specified by a user by actuating a control (e.g., button, slider, or ring) implemented by stylus 200. Each switch implementation of element 230 has a subset of the functions of one type of variable sensor implementation of element 230, in the sense that the switch has either of two states (open or closed, or 0 or 100%), whereas the sensor can be indicative of more than two states (e.g., a continuous range of levels). One type of sensor implementation of element 230 is (or includes or is coupled to) a filter configured to filter an audio signal from host 201. The audio signal can be received from host 201 on the left audio channel of cable 260, or on the right audio channel of cable 260, or two audio signals can be received from host 201: one by one sensor 230 from the left audio channel of cable 260; the other by another sensor 230 from the right audio channel of cable 260.

When the filtered signal is returned to the host 201 (via mixer 232 and the microphone channel of cable 260), the filtered signal can be transformed into digital data (in element 208 of host 201) and the data can be processed by an appropriately programmed processor 202 in host 201 to determine the output of the relevant sensor (and/or to identify which of several sensors in the stylus the signal is indicative of).

Processor 202 of FIG. 10 may generate through signal generation software layer 209, and host 201 may then assert to stylus 200 over one or more of the channels of cable 260, audio signals comprising frequency components of multiple frequencies that are mixed together or as a single frequency. These signals can be returned (looped back, with optional filtering and attenuation) from elements 220, 221, 222, 223, 230, 231, 232, and 240 to the host, or not returned to the host, depending on the state of passive switched circuitry in stylus 200. For example, signals asserted from host 201 to element 220 of stylus 200 on the left audio channel of cable 260 can have a first frequency content (e.g., can comprise frequency components in a first band), signals asserted from host 201 to element 222 of stylus 200 on the right audio channel of cable 260 can have a different frequency content (e.g., can comprise frequency components in a second band), and signals asserted from host 201 to one of elements 230 of stylus 200 on the left (or right) audio channel of cable 260 can have a different frequency content (e.g., can comprise frequency components in a third band). Or, signals asserted from host 201 to elements 220 222, and 230 via cable 260 can all have the same frequency content, and each of filters 221, 223, and 231 can be a band pass filter having a distinctive pass band, for easier discrimination processing (by host 201) of signals returned to the host from mixer 232 and element 240 of stylus 200 in response to these signals.

In some implementations of the FIG. 10 system, switched circuitry of stylus 200 presents a capacitive load (e.g., couples a capacitive load through closed switch 250 or 251 and conductive material of shaft 212 of the stylus from a user's hand which grips the shaft, or couples capacitor 213 or 214, or by direct connection to the GNDcontact which uses the host device as the capacitance) to a tip (210 or 211) of the stylus in contact with touch screen 205 and thereby to conventional touch screen sensors (in or associated with screen 205) to cause the touch screen to sense a “touch” event (“Event 1”). The switch which presents this load to the stylus tip may be biased to be open when less than a threshold force is exerted on the tip (e.g., by a capacitive touch screen in contact with the tip). However, this in itself does not disambiguate between a stylus tip touch and a finger (or hand) or other non-stylus touch. Thus, the switched circuitry of stylus 200 preferably includes at least one other switch which, when closed (or opened in some embodiments) in a second event (“Event 2”), closes an open loop (or opens a closed loop in some embodiments) between stylus 200 and host touch screen device 201, said loop including a left or right audio output channel of cable 260 (connected between stylus 200 and host 201), circuit elements in stylus 200, and another channel (e.g., the microphone channel) of cable 260. In response to Event 2, circuitry in the touch screen device (e.g., audio circuitry 208 which is normally used to process microphone input signals and processor 202) also senses a “touch” event (and optionally also receives and recognizes the output of one or more sensors and/or switches 220, 222, and 230 within stylus 200). Processor 202 of touch screen device 201 is programmed to interpret, as a stylus touch, the occurrence of “Event 1” within a predetermined time window (“x” seconds) of “Event 2.” The stylus may be physically constructed to present “Event 1” or “Event 2” in either order. Processor 202 is also programmed to interpret, as a non-stylus touch, the occurrence of “Event 1” that is not followed within x seconds (or not preceded by x seconds, in some embodiments) by an “Event 2.” The duration of the window “x seconds” is preferably predetermined in a manner that depends on expected processing delays (e.g., the delay inherent in any required processing of the signals, such as a Fourier transform, sensed by touch screen device 201 including its screen circuitry and its audio circuitry).

In the second class of embodiments, the capacitive touch stylus has at least a first mode of operation and a second mode of operation, and includes at least one conductive tip (each, preferably, a conductive felted tip) and passive switched circuitry including at least one switch (e.g., one or more of the switches of the switched circuitry of stylus 45 of FIG. 9, or element 220 or 222 (implemented as a switch) of FIG. 10, or switch 250, 251, 252, or 253 of FIG. 10), biased in a default state indicative of the first mode of operation but switchable into a second state indicative of the second mode of operation in response to movement of the tip, where the switch is coupled to the tip in one of the default state and the second state. Typically, movement of the tip in response to exertion of not less than a threshold force on the tip (e.g., by a touch screen in response to user-exerted pushing force on the stylus against the screen) is required to transition the switch from the default state to the second state. The switched circuitry also includes a stylus audio port set (e.g., stylus audio port set 240 of FIG. 10, or the stylus audio port set comprising ports L, R, MIC, and GND of FIG. 9) including at least one audio port configured to be coupled to an audio cable (e.g., cable 49 of FIG. 9). In typical embodiments in the second class, the stylus audio port set includes at least one audio input port (e.g., left channel input audio port L or right channel input audio port R of FIG. 9), and at least one audio output port (e.g., microphone port MIC of FIG. 9), and optionally also a ground port (e.g., ground port GND of FIG. 9). Preferably, the stylus audio port set is configured to be coupled to an end of a conventional audio cable (e.g., cable 49 of FIG. 9) including left and right output channel connectors, a microphone channel connector, and a ground connector, so that another end of the cable can be coupled to an audio port set (referred to herein as a “host audio port set”) of a touch screen device, where the touch screen device includes an audio subsystem including the host audio port set, and the host audio port set (e.g., host audio port set 204 of FIG. 10, or the host audio port set comprising ports L′, R′, MIC′, and GND′ of FIG. 9) typically includes least two audio output ports (configured to assert left and right output audio channels), an audio input port (configured to receive an audio input from a microphone), and a ground port.

Typically, the first mode of operation is use of the stylus with its tip in contact with a capacitive touch screen (or other object) with not less than a threshold force being exerted by the object on the tip, and the second mode of operation is other use of the stylus (e.g., use with the tip in contact with an object with less than the threshold force exerted by the object on the tip). For example, stylus 45 of FIG. 9 has a first mode of operation (in which tip T2 is pressed against screen 42 with force sufficient to translate post P2 far enough (and with sufficient velocity) to open switch S4 and then to close switch S3 within a predetermined time window after switch S4 opens). Processor 41 (of device 40 of FIG. 9) is programmed to recognize that stylus 45 is in this state in response to determining that the loop comprising the right channel conductor of cable 49 (and resistor R5, capacitor C1, and switch S4 of the switched circuitry of stylus 45) has transitioned from a closed to an open state, and then receiving from touch screen 42 (within the predetermined window) an indication of a touch on screen 42. Processor 41 assumes that stylus 42 is in the second mode of operation until transitions in the states of switches S3 and S4 of stylus 45 occur with the appropriate timing to cause processor 41 to recognize that stylus 45 is in the first mode of operation. With stylus 45 in the first mode of operation, a further change in state of one (or both) of switches S3 and S4 is recognized by processor 41 as entry of stylus 45 into its second mode of operation.

In other typical embodiments in the second class (e.g., those in which the stylus has a conductive shaft that couples the capacitance of a human gripping the shaft to switched circuitry within the shaft), the first mode of operation is use of the stylus with its tip in contact with a capacitive touch screen (or other object) with not less than a threshold force being exerted by the object on the tip and the stylus gripped by a user (such that not less than a threshold capacitance is coupled by switched circuitry from the user to the tip), and the second mode of operation is other use of the stylus (e.g., use with the tip in contact with an object with less than the threshold force exerted by the object on the tip, or with less than the threshold capacitance coupled from to the tip).

In some typical embodiments in the second class (e.g., in operation of stylus 45 of above-described FIG. 9), the first mode of operation is use of the stylus with occurrence of two events within a predetermined time window: a threshold capacitance is coupled to the tip (e.g., a capacitance internal to the stylus, e.g., capacitance 213 or 214 which is internal to stylus 200 of FIG. 10, or external to the stylus but coupled to the stylus by the switched circuitry, e.g., the capacitance of cable 49 of FIG. 10) in response to exertion of not less than a threshold force on the tip (e.g., by a capacitive touch screen or other object in contact with the tip, as the tip is forced against the object); and a signal is asserted (e.g., for transmission via an audio cable or other wired link, or a wireless link, to a touch screen device) other than by coupling a capacitance to the tip, but in response to exertion of force on the tip (e.g., by a capacitive touch screen or other object in contact with the tip). In these embodiments, the second mode of operation is other use of the stylus (e.g., use with occurrence of one but not both of these events, or with both of the events occurring but not within a predetermined time window). The predetermined time window is typically sufficiently wide to allow processing circuitry in a host device (e.g., processor 202 of touch screen device 201 of FIG. 10, or processor 41 of touch screen device 40 of FIG. 9) to recognize and distinguish between the two events, but sufficiently short so that both events occur in response to a single touch of the stylus on a capacitive touch screen by a user who intends to indicate information to the touch screen device.

In some embodiments in the second class (e.g., stylus 200 of FIG. 10 including elements 250 and 251, and with shaft 212 being a conductive shaft), the stylus has a conductive tip (e.g., a conductive, felted tip) that is continuously coupled to a sufficient capacitance (when a human user grips the stylus) to allow a capacitive touch screen device to recognize (as a touch) simple contact of the tip on the screen of the touch screen device, and the switched circuitry has a first state which allows the stylus to assert to the touch screen device (e.g., forward to, or loop back from, the touch screen device) a signal (when the stylus is coupled by an audio cable or other link to the touch screen device) that indicates to the touch screen device that the screen (or another object) is exerting at least a threshold force on the stylus tip. The switched circuitry also has a second state which prevents the stylus from asserting such signal to the touch screen device, thereby indicating to the touch screen device that the screen (or other object) is not exerting force (or is exerting less than the threshold force) on the stylus tip.

In some embodiments in the second class, the stylus has a first conductive tip at one end (e.g., a conductive felted tip), and a second conductive tip at another end (e.g., another conductive felted tip). The first conductive tip (e.g., at a “writing” end of the stylus) is configured to be moved into a position causing the switched circuitry to enter a first state coupling a capacitance to the tip and closing a loop between a first input port (e.g., a left audio channel input port) of the stylus audio port set and at least one output port of the stylus audio port set, where the capacitance is sufficient to allow a capacitive touch screen device (e.g., a conventional capacitive touch screen device) to recognize (as a touch) simple contact of the first conductive tip on the screen of the touch screen device. Preferably, the switched circuitry is implemented so that both these events (coupling of the capacitance to the first conductive tip, and opening (open-circuiting) the loop between the first input port and at least one output port of the stylus audio port set) occur within a predetermined time window. In response to the first conductive tip being in another position, the switched circuitry enters a second state decoupling the capacitance from said first conductive tip and/or closing the loop between the first input port and said at least one output port of the stylus audio port set. The second conductive tip (e.g., at an “erasing” end of the stylus) is configured to be moved into a position causing the switched circuitry to enter a third state coupling a capacitance to the tip and closing a loop between a second input port of the stylus audio port set (e.g., a right audio channel input port) and at least one output port of the stylus audio port set, where the capacitance is sufficient to allow a capacitive touch screen device (e.g., a conventional capacitive touch screen device) to recognize (as a touch) simple contact of the second conductive tip on the screen of the touch screen device. Preferably, the switched circuitry is implemented so that both these events (coupling of the capacitance to the second conductive tip, and opening (open-circuiting) the loop between the second input port and said at least one output port of the stylus audio port set) occur within a predetermined time window. In response to the second conductive tip being in another position, the switched circuitry enters a fourth state decoupling the capacitance from the second conductive tip and/or closing the loop between the second input port and said at least one output port of the stylus audio port set.

In some embodiments, the invention is a system including a stylus (which belongs to the second class of embodiments), a touch screen device having an audio subsystem (including a host audio port set of the type mentioned above) and a processor coupled to the audio subsystem, and an audio cable connected between the stylus audio port set of the stylus and the host audio port set of the touch screen device, wherein the processor of the touch screen device is configured to recognize an operating mode of the stylus in response to at least one response signal received at the host audio port set in response to assertion of at least one signal from the audio subsystem via the host audio port set and the cable to the stylus audio port set.

In some embodiments, the state of the stylus audio port set (e.g., in response to the state of the host stylus audio port set) is indicative of one or more of: contact between a tip of the stylus and a touch screen (or other object); pressure exerted by a touch screen (or other object) on a tip of the stylus; state of at least one sensor of the switched circuitry (e.g., element 220, 222, or 230, implemented as a sensor, of FIG. 10); and state of at least one switch (e.g., element 220, 222, or 230, implemented as a switch, of FIG. 10) of the switched circuitry. In some such embodiments, the switched circuitry includes at least one filter coupled and configured to filter at least one signal received from a touch screen device (via an audio cable) at the stylus audio port set, thereby generating a filtered signal, and the switched circuitry is configured to assert the filtered signal at the stylus audio port set (for transmission to the touch screen device (via the audio cable).

Typical embodiments in the second class provide a means for communicating mode information from a stylus to a host that allows the host to distinguish between intended touches of the stylus (on a capacitive touch screen) and other touches not intended to be strokes or other kinds of drawing/writing information (such as erasures). Rather than to assert mode information actively from a locally powered (active) stylus (including powered sensors and/or switches for determining and asserting the mode information) via wireless communication to or direct stimulation of the host, preferred embodiments of the invention use purely passive switched circuitry in a stylus to assert mode information to a host via a conventional audio port set conventionally present in the host and a cable coupled between the stylus and the host. These preferred stylus embodiments do not pulse or otherwise communicate any information through a stylus tip other than simple contact (which is recognizable in a conventional manner by a conventional touch screen device).

In a third class of embodiments of the stylus, the stylus has a conductive tip (e.g., a conductive, felted tip) and includes passive switched circuitry having a first state which couples a capacitance to the tip, where the capacitance is sufficient to allow a capacitive touch screen device (e.g., a conventional capacitive touch screen device) to recognize (as a touch) simple contact of the tip on the screen of the touch screen device, and a second state which decouples the capacitance from the tip, thereby preventing the touch screen device from recognizing (as a touch) simple contact of the tip on the screen. For example, stylus 45 of FIG. 9 includes passive switched circuitry having a first state (in which switch S2 or S4 is closed) in response to a tip (T1 or T2) being pressed against screen 42 with force sufficient to translate post P1 (or P2) far enough away from its default position to close switch S2 or S4. The switched circuitry of stylus 45 of FIG. 9 also has a second state (in which both switches S2 and S4 are open) in response to neither of tips T1 and T2 being pressed against screen 42 with force sufficient to translate post P1 (or P2) far enough away from its default position to close switch S2 or S4.

In some embodiments in the third class (e.g., in the FIG. 9 embodiment), the capacitance is a capacitive load external to the stylus (i.e., the capacitive load of cable 49 coupled to stylus 45). Alternatively, the capacitance can be internal to the stylus (e.g., capacitance 213 or 214 of implementations of stylus 200 of FIG. 10 that include elements 213, 214, 252, and 253). Typically, the passive switched circuitry (of embodiments in the third class) includes at least one switch biased in a default state (e.g., the default state of switch S2 or S4 of FIG. 9) which couples the capacitance to (or decouples the capacitance from) the tip but is switchable into a second state (which decouples the capacitance from (or couples the capacitance to) the tip in response to movement of the tip (typically, movement of the tip in response to exertion of not less than a threshold force on the tip, e.g., by a touch screen in response to user-exerted pushing force on the stylus against the screen), where the switch is coupled to the tip in one of the default state and the second state. The switched circuitry also includes a stylus audio port set (e.g., port set 240 of FIG. 10, or ports L, R, MIC, and GND of FIG. 9) including at least one audio port configured to be coupled to an audio cable. In typical embodiments in the third class, the stylus audio port set includes at least one audio input port, and at least one audio output port, and optionally also a ground port. Preferably, the stylus audio port set is configured to be coupled to an end of a conventional audio cable (e.g., cable 49 of FIG. 9) including left and right output channel connectors, a microphone channel connector, and a ground connector, so that another end of the cable can be coupled to an audio port set (referred to herein as a “host audio port set”) of a touch screen device, where the touch screen device includes an audio subsystem including the host audio port set, and the host audio port set typically includes least two audio output ports (configured to assert left and right output audio channels), an audio output port (configured to receive an audio input from a microphone), and a ground port.

In various embodiments, the stylus is a powered, non-powered, active, or passive device. For example, it is contemplated that some embodiments of the stylus are (e.g., the switched circuitry thereof is) specially designed to draw power (e.g., about one half of a Watt) from an audio output channel (and/or other channels) of a cable connected between the stylus and a host, for use by op amps or other circuit elements in the stylus. In operation, other embodiments of the stylus would not draw power from a host (or would draw no more than an insignificant amount of power from a host, e.g., no more than very small amounts of power unavoidably dissipated as heat due to resistance of circuit elements in the stylus).

In some embodiments, the stylus for a capacitive touch screen is configured to mechanically stimulate the touch screen and to assert modal information to the touch screen by patterned disconnection of a capacitive load (either external to the stylus, e.g., provided by the body of a human gripping the stylus, or internal to the stylus) via purely mechanical means of winding or shaking. For example, the stylus is capable of being powered (e.g., re-charged) in response to a shaking, twisting, or general user motion by means of an internal mechanism that translates the mechanical energy into electrical energy (e.g., for recharging a battery local to the stylus, or for use directly by the stylus for its operation). The touch screen is configured to implement a method for recognizing such a stimulus pattern to select a modality of interaction with the stylus.

In some embodiments, the stylus is configured to stimulate a capacitive touch screen mechanically and to communicate modal information to the touch screen (e.g., by patterned disconnection of circuitry within the stylus) via a wireless link (e.g., an RF link), where power consumed by the stylus during operation is derived from mechanical means local to the stylus (e.g., within the stylus), e.g., by shaking or twisting the body of the stylus. The touch screen is configured to implement a method for recognizing such a stimulus pattern to select a modality of interaction with the stylus.

In some embodiments, the stylus is configured to stimulate a capacitive touch screen mechanically and to communicate (to the touch screen) stylus identification data that uniquely identifies the stylus (or a user thereof). The touch screen device is configured (e.g., includes a processor programmed with application software) to identify the stylus (or user) in response to the stylus identification data, e.g., so that the touch screen device can operate in different modes in response to input from each of multiple styli. For example, the touch screen device implements an annotation application that uses a unique identification of each stylus to identify a unique user and to capture and/or display the user's name and or other specific information that is tied to that user.

In some embodiments (e.g., some implementations of device 40 of FIG. 9 and some implementations of device 201 of FIG. 10), the capacitive touch screen device is configured to recognize (e.g., processor 41 of FIG. 9, or processor 202 of FIG. 10, is programmed to recognize) an operating mode of an embodiment of the stylus (e.g., stylus 45 of FIG. 9 or stylus 200 of FIG. 10) in response to at least one signal indicative of the state of switching circuitry in the stylus, and in response to touch screen sensor data (i.e. data generated and processed conventionally in touch screen devices to calculate a centroid from an outline of an object's contact area on a touch screen) including by processing the touch screen sensor data in at least one of the following ways: recognizing movement of the stylus on the screen and predicting a future location of contact area of the stylus on the screen (e.g., by determining a sequence of centroids of outlines of the moving stylus's contact areas on the touch screen and projecting a next centroid from the sequence); determining velocity of contact area of the stylus on the screen; and determining size of contact area of the stylus on the screen. This can allow (or help to allow) the touch screen device to disambiguate between user-intended stylus touches on the screen and non-intended or spurious touches. For example, the touch screen device may be configured to recognize a touch on the screen as an intended stylus touch only in response to receiving a signal indicative of the state of switching circuitry in the stylus within a predetermined time window of determining (from the touch screen sensor data) that a detected touch on the screen occurs at a location matching a predicted future location of a moving stylus on the screen.

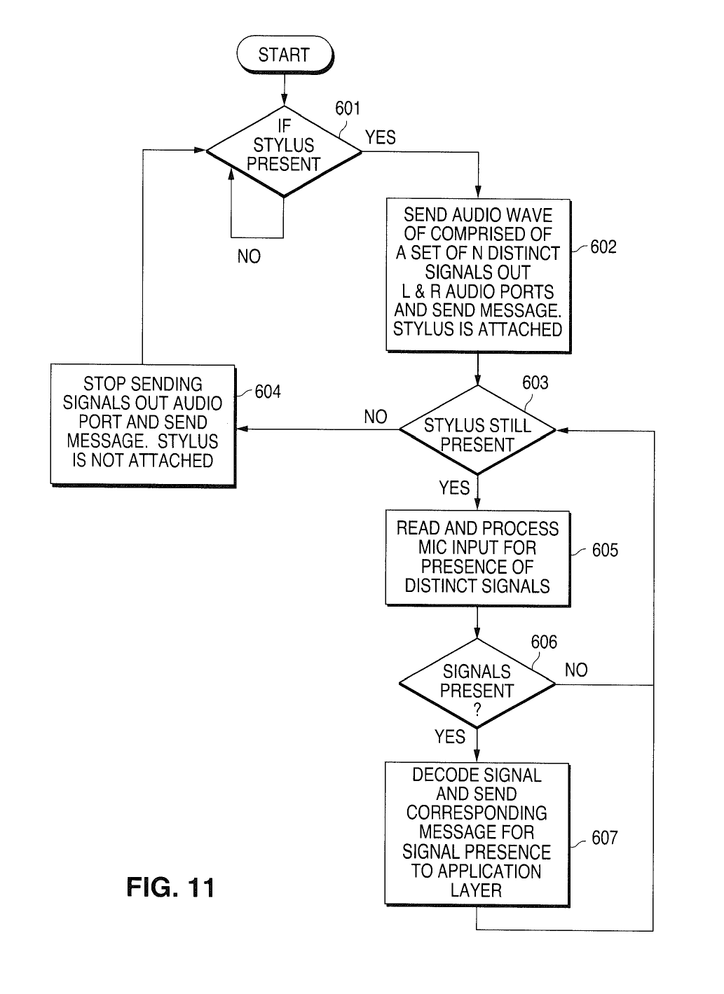

FIG. 11 is a flow chart of steps performed in operation of an embodiment of the stylus and a capacitive touch screen device (e.g., by stylus 200 and touch screen device 201 of FIG. 10). At step 601, the device determines if the stylus is or may be present (e.g., in a conventional manner using conventional capacitive touch screen sensors associated with the device's touch screen to sense a touch on the screen). If it is determined that a stylus is or may be present, the device (e.g., device 210) asserts (in step 602) audio signals (e.g., a set of N distinct signals) over left and right audio channels of a cable coupled between the stylus and the device (e.g., device 201 asserts audio signal to left, “L”, and right, “R”, audio output ports of port set 204 for transmission to stylus 200 over left and right channels of cable 260). If the device determines that the stylus is no longer present (in step 603), it ceases to assert the audio signals (step 604). If the device determines that the stylus continues to be or may be present (in step 603), it reads and processes (in step 605) the signal received at an input audio port (e.g., device 201 reads and processes the signal received from stylus 200 via cable 260 at the microphone input port of port set 204). If a return signal is determined (in step 606) to have been received at the input audio port (e.g., because switch 220 or 222 is closed in response to sufficient actuation force exerted by touch screen 205 on tip 210 or 211 of stylus 200), the device (e.g. processor 202 of device 201) decodes the return signal and sends a corresponding message (determined by the decoded return signal) indicative of stylus presence at the screen (and optionally also indicative of at least one characteristic of a stroke by the stylus on the screen) to an application layer (e.g., of software executed by processor 202) and the device then repeats step 603 to continue to monitor whether the stylus is present. If a return signal is not determined (in step 606) to have been received at the input audio port, the device repeats step 603 to continue to monitor whether the stylus is present.

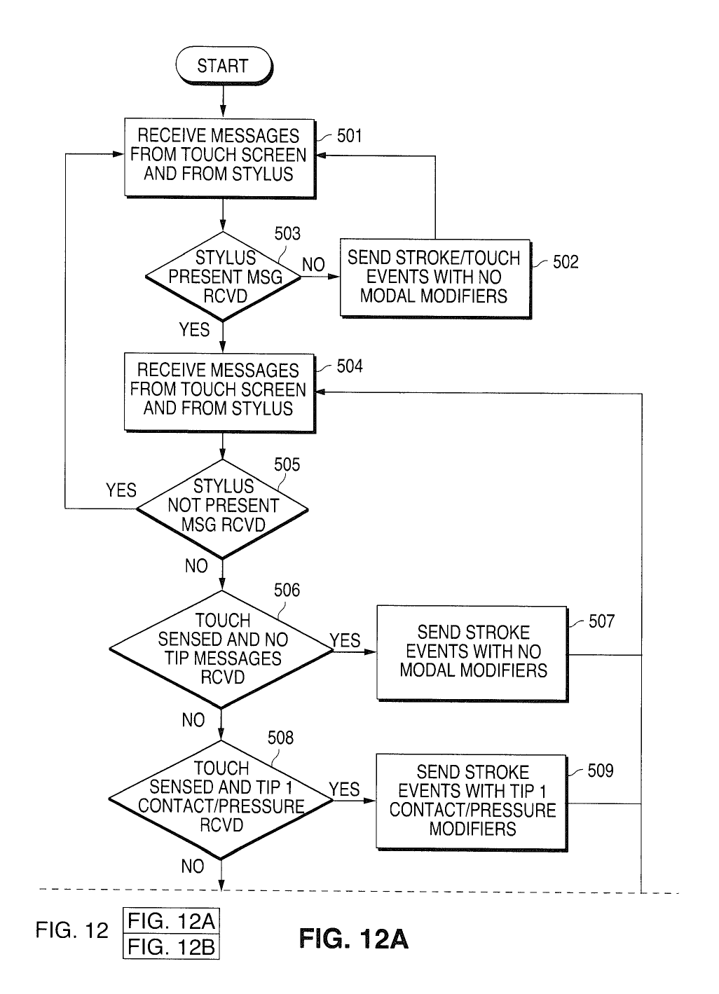

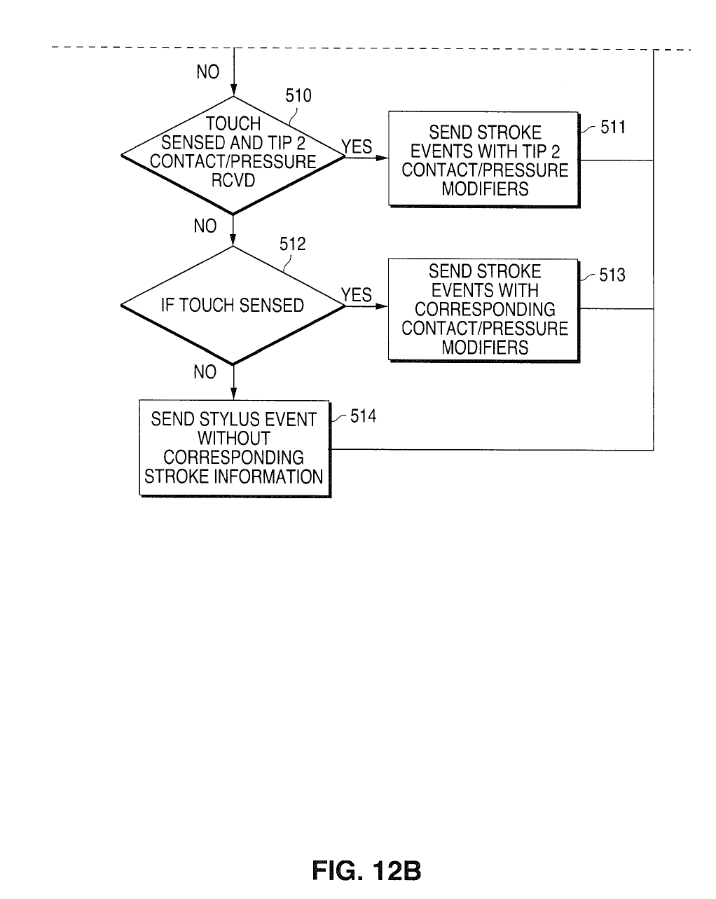

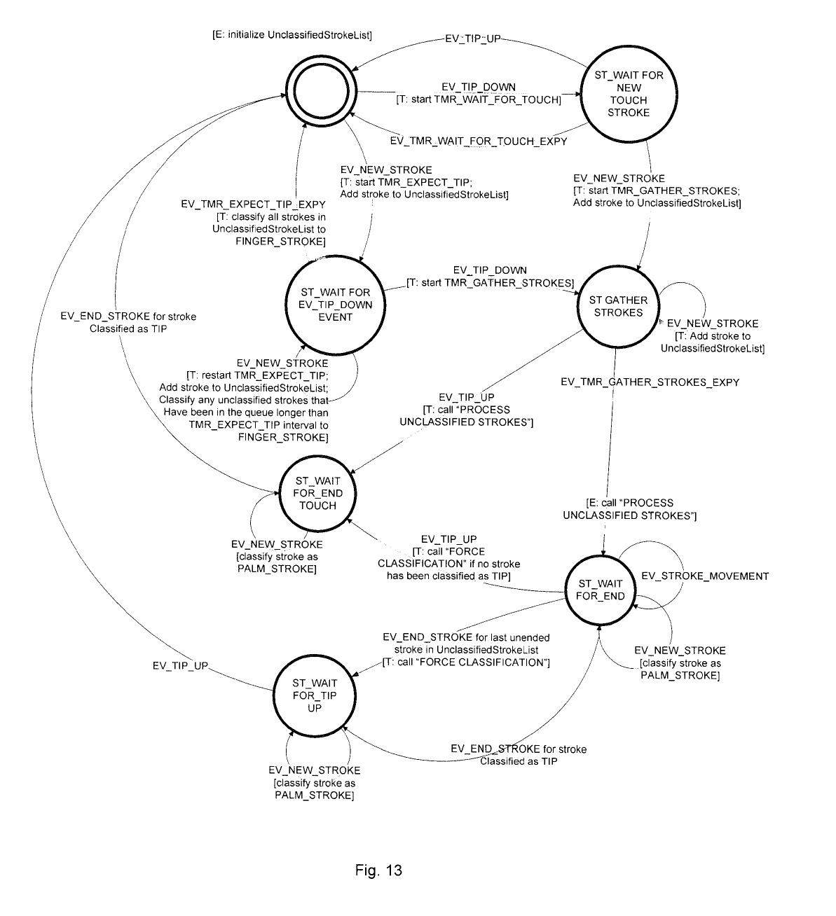

FIG. 12 is another flow chart overview of steps performed in operation of an embodiment of the stylus and a capacitive touch screen device (e.g., by stylus 200 and touch screen device 201 of FIG. 10). At step 501, the device (e.g., processor 202 of device 201) is receptive to data (messages) from the device's touch screen (e.g., data generated in a conventional manner using conventional capacitive touch screen sensors associated with the touch screen to sense a touch on the screen) and from the stylus (e.g., via cable 260). If the device determines (in step 503) that a stylus (an embodiment of the stylus) is not present, the device (in step 502) assumes that any touch sensed by the touch screen is by a human finger (or other object that is not an embodiment of the stylus) and operates conventionally (e.g., by producing a display.

If the device determines in step 503 (e.g., by receiving a return signal on cable 260 in response to an audio signal asserted on the left channel and/or the right channel of cable 260) that a stylus (an embodiment of the stylus) is present, the device (in step 504) continues to be receptive to data (messages) from the device's touch screen (e.g., data generated in a conventional manner using conventional capacitive touch screen sensors associated with the touch screen to sense a touch on the screen) and from the stylus (e.g., via cable 260).

If the device then determines in step 505 (e.g., by failing to receive a return signal on cable 260 in response to an audio signal asserted on the left channel and/or the right channel of cable 260) that a stylus is not present, it returns to step 501. If the device determines in step 505 that a stylus is present, the device proceeds to perform one or more of steps 506, 508, 510, and 512.

If the device determines in step 506 (e.g., by recognizing an indication of a touch on the touch screen from conventional touch screen sensors associated with the touch screen, without any accompanying change in status of a return signal from the stylus via cable 260) that there has been a touch on the screen by a stylus (i.e., an embodiment of the stylus), it operates (in step 507) by producing a display in response to the touch (without modifying the display in response to any modal modifier).

If the device determines in step 508 there has been a touch on the screen by a first tip of an embodiment of the stylus (e.g., by recognizing occurrence of two events within a predetermined time window: an indication of a touch on the touch screen from conventional touch screen sensors associated with the touch screen; and a change in status of a return signal from the stylus via cable 260 indicative of a touch by the first tip of the stylus, where the first tip may be a “marking” tip of the stylus), it operates (in step 509) by producing a display in response to the touch (optionally in a manner modified in response to at least one modal modifier received from the stylus, e.g., via cable 260 from a sensor 230 of the stylus).

If the device determines in step 510 there has been a touch on the screen by a second tip of an embodiment of the stylus (e.g., by recognizing occurrence of two events within a predetermined time window: an indication of a touch on the touch screen from conventional touch screen sensors associated with the touch screen; and a change in status of a return signal from the stylus via cable 260 indicative of a touch by the second tip, where the second tip may be an “erasing” tip of the stylus), it operates (in step 511) by producing a display (e.g., erasing a previously displayed mark on the screen) in response to the touch (optionally in a manner modified in response to at least one modal modifier received from the stylus, e.g., via cable 260 from a sensor 230 of the stylus).

If the device determines in step 512 there has been a touch on the screen by an unidentified tip of an embodiment of the stylus (e.g., by recognizing occurrence of two events within a predetermined time window: an indication of a touch on the touch screen from conventional touch screen sensors associated with the touch screen; and a change in status of a return signal from the stylus via cable 260 indicative of a touch by at tip of the stylus), it operates (in step 513 or 514) by producing a display in response to the touch (e.g., with the assumption that the touch is intended to cause display of a mark rather than to erase a previously displayed mark, unless the touch is accompanied by a modal modifier indicating an erasure) in a manner modified in response to any modal modifier(s) received from the stylus, e.g., via cable 260 from at least one sensor 230 of the stylus), and then returns to step 504. Specifically, the device produces the display (in step 513) in a manner modified in response to at least one modal modifier received from the stylus, or the device produces the display (in step 514) an unmodified manner (e.g., a default manner) if no modal modifier received from the stylus.

In some embodiments, the tip actuation signals from the stylus to the host device may be provided to the host device through, for example, the DOCK connector of a host device that provide power to the stylus from the host device (the DOCK connector is a docking connector that has multiple signals in it: audio, USB, RS232, etc). The tip actuation signals may also be provided through a USB connection (that is also may provide power to the stylus from the host device) through a USB cable. The tip actuation signal may be provided to the host device utilizing any data communications protocol (e.g., RS232, WiFi, BlueTooth, CAN, etc.); if it is a wireless protocol, then stand-alone power source (e.g., battery) is needed. An aspect of the tip-to-touch disambiguation algorithm relies on a data communications means, either parallel or serial, that is capable of representing and transmitting the following events in at least one direction (from the stylus to the host device) in a timely manner:

TIP(n) depressed (i.e., sufficient force applied)

TIP(n) released (insufficient force applied)

wherein n represents the tip number.

FIG. 13 is a detailed state diagram that is illustrative of data gathering and processing techniques (summarized in FIG. 12) useful in classifying touches or strokes on the capacitive touch screen into various types of strokes such as stylus/tip, finger or palm touches according to an embodiment of the invention. It describes in detail a specific “time window disambiguation” technique to properly identify which tip events correspond to the stroke events. It is not the only technique capable of stroke classification. There are others that may be used and that are known to those of ordinary skill in the art.

FIG. 13 contains seven states:
Initialize Unclassified Stroke List 610;
Wait for Tip Down Event 612;
Wait for End Touch 614;
Wait for Tip Up 616;
Wait for New Touch Stroke 618;
Gather Strokes 620;
Wait for End 622.

FIG. 13 contains the description of the events and transitions that occur from state to state, and the interrelationship between states.

In the FIG. 13 state diagram, all active timers are stopped on their expiry or on transition to a new state. On FIG. 13, the prefix “E: . . . ” denotes finite state machine entry actions into states (to be executed even if the state vectors to itself.). The prefix “T: . . . ” denotes finite state machine transition actions. In certain embodiments, TMR_WAIT_FOR_TOUCH is approximately 200 msecs. TMR_GATHER_STROKES is approximately 100 msecs. TMR_EXPECT_TIP is approximately 200 msecs.

The stylus must ultimately provide information to the software applications on the host, typically the capacitive touch screen device itself. It is possible that the capacitive touch screen device is a client to another host. Even though the present description does not explicitly describe that configuration, the stylus stroke classification technique is still applicable even when the processing takes place on another device. While there are many applications that may use the stylus, the most common applications are electronic annotation, note taking, or drawing software running on the host device. It is useful for these applications have each stroke classified into four distinct categories: “STROKE_UNCLASSIFIED” which is a temporary state denoting that the algorithm does not yet have enough information to determine the stroke type; “TIP_STROKE(n)” (where n denotes the unique tip that originated the event) which denotes that the stroke has been successfully categorized as a having been generated by a tip interacting with the touch screen; “FINGER_STROKE” which indicates that the stroke was generated by the user's finger; and “PALM_STROKE” which identifies the stroke as a spurious un-intentional stroke that was created by the palm touching the surface or other non-intended user stroke.

The time window technique (e.g., processing strokes by comparing the time of the event to a predetermined time interval that starts upon T1 the transition from stylus tip up to tip down) alone does not ultimately serve to fully classify all strokes as there may be multiple stroke events that begin within the time window of T_{window} seconds between the occurrences of the tip down events and touch start events; more than one touch event may start within that window (e.g., the user's palm and the stylus touch the surface within the same time window). The classification or disambiguation described with reference to the FIG. 13 finite state machine relies on two algorithms to further disambiguate the strokes called “PROCESS UNCLASSIFIED STROKES” which may or may not arrive at a final classification of all strokes as new touch locations are processed by the algorithm; and “FORCE CLASSIFICATION” which forces the election of a single stroke to be classified as a TIP_STROKE, while classifying all others as PALM_STROKEs.

Definition of terms. A stroke as referred to in this embodiment is defined as an ordered set of points, (corresponding to the contact location on the touch screen) including the timestamp for when the point was captured by the host device. Thus, a stroke is an ordered sequence of ordered pairs {[(x₁, y₁), t₁], . . . [xₙ, yₙ), tₙ]}, where, for all i from 1 to n, (xᵢ, yᵢ) is the two-dimensional location of the ith point corresponding to the contact location recorded at time tᵢ. For any i from 1 to n−1, the ith stroke segment is defined as the line segment connecting two consecutive point locations of the stroke (xᵢ, yᵢ) to (xᵢ₊₁, yᵢ₊₁). The stroke path is the connected polygonal path connecting the point locations of the stroke. A centroid of the stroke is defined as the center of mass of the collection of point locations of the stroke.

The process “PROCESS UNCLASSIFIED STROKES” is executed for each unclassified stroke in the set of unclassified strokes gathered by the finite state machine above. These strokes represent the possible tip generated strokes (referred to as “tip strokes” as compared with palm generated strokes (referred to as “palm strokes”)). It is known that tip strokes exhibit a set of characteristics that are distinguishable from the set of characteristics exhibited by palm strokes. This process converges on selecting one stroke from among the set of strokes that is the likeliest to be the tip stroke by a set of heuristics that differentiate between the two sets of palm stroke characteristics and tip stroke characteristics. The process establishes a continually updated probability for each stroke in the set of unclassified strokes based on the heuristics detailed below. Once a probability that a stroke is a tip stroke reaches 0, or some threshold value close to zero, that stroke is immediately assigned as a palm stroke and removed from the set of unclassified strokes. If only one stroke remains in the set, then it is classified as the tip stroke and the process is complete. For each stroke in the set of unclassified strokes there are two types data points that can be appended to the stroke based on continued tracking of those strokes: “stroke is moving” (which results in a new segment of the stroke path to be appended to the existing stroke path, and “stroke has ended” (resulting from the tip and or palm having been lifted from contact with the touch screen). “PROCESS UNCLASSIFIED STROKES” is executed as soon as the strokes are gathered (as shown in the finite state machine of FIG. 13), and each time a new data point [(xᵢ, yᵢ), tᵢ] is added to the end of the stroke sequence. The finite state machine will have already eliminated all possible strokes that do not fall into the previously described time window, and new strokes that may occur outside of that time window are not added to the set of unclassified strokes, but instead immediately classified as palm strokes.

The first time “PROCESS UNCLASSIFIED STROKES” is executed (i.e. after the transition from “ST_GATHER_EVENTS”), for each stroke in the set of unclassified strokes, the initial probability that the stroke should be classified as a tip stroke is generated by determining the acceleration between the end of the previously classified tip stroke and applying a mathematical function to calculate an approximation that the probability that the stroke is a tip stroke. The beginning point of each stroke is compared to the ending point of the last categorized tip stroke to determine an acceleration vector with magnitude, a. The “acceleration probability function” is applied to calculate an approximation for the probability that the stroke is a tip stroke. If there is no previous tip stroke then the probability is assigned to 1.

A piecewise linear acceleration probability function such as the following may be used to calculate an approximation for the probability that a stroke is a tip stroke:

$$\begin{matrix}P ( a ) = 1 if a < threshold {A}_{1} \\ = ( {A}_{2} - a ) / ( {A}_{2} - {A}_{1} ) if a >= threshold {A}_{1} and \\ a < threshold {A}_{2} \\ = 0 otherwise .\end{matrix}$$

This function establishes three ranges. Below a certain acceleration value A₁, the probability that the stroke is a tip stroke is one; above or equal to A₁, but below A₂, the probability that the stroke is generated by the tip decreases linearly to zero. For accelerations above point A₂ the probability that the stroke is a tip stroke is zero. This processing allows us to use a model of human hand motion assuming that there is a maximum acceleration that can be achieved by the at the tip of a stylus held by an average human hand during writing; and that, as the acceleration rises, the likelihood that the stroke was generated by a stylus tip held by a human hand decreases to zero according to the function above.

Differentiable (i.e., smooth) functions whose general shape resembles the piecewise linear acceleration probability function may also be used to approximate the probability that a given stroke is a tip stroke. One example is a logistic function such as

P(a)=[1/(1+êa)]+[(A₁+A₂)/2],

where e is the base of the natural logarithm.
This logistic function has asymptotes at P=0 and P=1 rather than fixing boundaries for when the probability is exactly zero or one.

For each segment in each unclassified stroke, the process refines the probability based on the following techniques:
Velocity thresholding: the velocity ν of a stroke segment is calculated, and ν is used in a mathematical function to calculate an approximation for a probability that the stroke is a tip stroke. For example, if velocity ν is greater than the threshold V₁, then the stroke can be immediately assigned a probability of zero. All probabilities are accumulated by multiplying the last calculated probability by the new calculated probability. In this case any stroke segment with velocity greater than V₁ would immediately be given a probability of zero, and therefore the whole stroke would be classified as a palm stroke. A decreasing, differentiable function of ν can also be used to determine if the probability of a given stroke is a tip stroke. One possibility is an exponential decay function such as

P(ν)=bê(rν),
where e is the base of the natural logarithm, b is positive, r is negative, and b and r are determined through statistical methods on a large data sample. In this case any stroke segment with velocity greater than some value based upon b and r, would be given a probability close to zero, thereby increasing the probability that the whole stroke would be classified as a palm stroke. If the data sample suggests a more complicated function is required, a suitable function will be chosen for the velocity probability function.
Acceleration Probability: the “Acceleration probability function” is applied to the acceleration derived from the distance and time between the ending point of the stroke, and the distance and time of the previous point in that stroke (e.g., the last segment of acceleration). All probabilities are accumulated by multiplying the last calculated probability by the new calculated probability. Any stroke that achieves a probability of zero or is below some threshold value close to zero is immediately classified as a palm stroke. The accumulated probability is known as Pa.
The process “FORCE CLASSIFICATION” is run once as (shown by the finite state machine in FIG. 13). It is executed once the tip is released AND there is more than one stroke remaining in the set of unclassified strokes. This process will choose the stroke most likely to be a tip stroke based on the accumulated probabilities of the steps above and the following techniques:
First, any strokes that are still active (i.e., not ended) within a time interval similar to the time interval (i.e., T_{window}) used to determine that a stroke was possibly a tip stroke must immediately be classified as a palm stroke. If only one stroke remains in the set then it is classified as the tip stroke and the process is complete.
If more than one stroke remains, for each unclassified the following 3 techniques further refine the probabilities calculated by the “PROCESS UNCLASSIFIED STROKES” process.
   Median Stroke Segment Lengths: For each segment in each unclassified stroke, calculate the median length of all stroke segments of a stroke. Calculate probability “Pm” by assigning the ratio of each of the median values to the maximum median value of all remaining unclassified stroke medians. This will assign a higher probability to all strokes with a higher median length. It is contemplated that using the median absolute deviation from the median (i.e., the MAD) or other statistic may also be similarly used.
   Dead Reckoning: Calculate a motion vector from up to 2 previously completed tip strokes that have all occurred within a time interval T prior to the starting time of the stroke being analyzed. If less than two strokes exist that meet that criteria, then assign probability “Pd” to 1. Otherwise, for each stroke that meets the criteria calculate a measure of the location or center (e.g., centroid) of each stroke. Use the two locations to calculate the velocity vector between them. Then calculate a point that would be the next point in sequence given a constant velocity. This gives the “dead reckoning point” for where the next tip stroke would be expected to be. Calculate the location or center (e.g., centroid) of each unclassified stroke. Calculate probability Pd of the location u of an unclassified stroke as

Pd(c)=1−(u−d)/s
where d is the dead reckoning point and s is the sum of all distances between each unclassified stroke center and the dead reckoning point. This will assign a higher probability Pd to the unclassified strokes with points (or centers) that are closest to the dead reckoning point.
Current Palm Placement: if any strokes previously classified as palm strokes are currently still active (i.e., an object is still in contact with the host device), calculate centroids (or other measure of the location) of each of those strokes. Calculate the centroid of all the centroids of the different active palm strokes. For each unclassified stroke, calculate the probability

Pp=(c−u)/s
where c is the centroid of palm centroids, u is the start of the unclassified stroke, and s is the sum of all distances from each unclassified stroke starting point to the centroid of palm centroids. This will assign a higher probability to each of the strokes that started furthest from the current palm centroid of centroids.
   Once Pd, Pm, and Pp have been calculated, for each unclassified stroke, apply the following formula:

Ptip=Pa*W1+Pd*W2+Pm*W3+Pp*W4
Where (W1+W2+W3+W4)=1 and W1 through W4 represent a weight between zero and one (inclusive) given to each probability.
   The stroke with the highest probability (Ptip) value is classified as a tip stroke. All others are classified as palm strokes.

It is contemplated that more sophisticated statistical methods can be applied to increase the reliability of the calculations for the individual probability functions Pa, Pd, Pm and Pp. Samples of data can be collected and analyzed using statistics to estimate the shape of the probability functions including the class or type of function and the parameters specific for each function.

It is contemplated that mechanical switches, on occasion, may be actuated so fast by hand movements that brief tip up/tip down events may be lost. The finite state machine of FIG. 13 assumes no loss of events. Refinements are contemplated that can take this loss of events into consideration based upon proximal distance and time from the last recognized stroke.

It should be understood that while some embodiments of the present invention are illustrated and described herein, the invention is defined by the claims and is not to be limited to the specific embodiments described and shown.

What is claimed is:

1. A stylus comprising:
a felted tip having a deformable conductive surface for contacting a capacitive touch screen, the tip having a contact area sufficient in magnitude and the tip is coupled to a capacitance sufficient in magnitude to cause the capacitive touch screen to recognize a touch by the tip; and
a structure supporting the tip and supporting an application of force to deform the tip conductive surface.

2. The stylus of claim 1, wherein the structure is a conductive shaft coupled to the tip.

3. The stylus of claim 1, wherein the tip is semi-rigid.

4. The stylus of claim 1, wherein the tip is made from a blend of conductive and non-conductive fibers.

5. The stylus of claim 1, wherein the tip comprises conductive fibers and base fibers that have been felted with the conductive fibers.

6. The stylus of claim 5, wherein the base fibers are wool fibers.

7. The stylus of claim 5, wherein the conductive fibers are carbon fibers.

8. The stylus of claim 5, wherein the conductive fibers are fibers coated with metal.

9. The stylus of claim 5, wherein the conductive fibers are fibers coated with carbon.

10. The stylus of claim 5, wherein the conductive fibers have electrical resistivity such that the combined resistance and capacitance of the tip, when the tip is coupled to the capacitance, in aggregate, is sufficient to cause the capacitive touch screen to recognize a touch by the tip, and the capacitance of the tip alone is insufficient to cause the capacitive touch screen to recognize a touch by the tip.

11. The stylus of claim 5, wherein the conductive fibers have electrical resistivity not more than on the order of 10,000,000 ohms-cm).

12. The stylus of claim 1, wherein the tip has an at least substantially bullet-like shape when in an undeformed state.

13. The stylus of claim 1, wherein the tip has an at least substantially hemispherical shape when in an undeformed state.

14. The stylus of claim 1, wherein the structure includes a conductive shaft, and said stylus also includes:
switched circuitry selectable to provide a configuration state that forms a low impedance path that couples an additional amount of capacitance to the tip, the combined capacitance sufficient to allow the capacitive touch screen to recognize a touch by the tip, and wherein the switched circuitry in an alternate state does not couple to sufficient additional capacitance to the tip to allow the capacitive touch screen to recognize a touch by the tip.

15. A system comprising:
a capacitive touch screen device comprising:
a capacitive touch screen surface;
a controller that defines a touch event on the capacitive touch screen surface by the touch event having at least a threshold contact area value and a threshold change in local capacitance value; and,
a stylus comprising:
a tip with a conductive surface coupled to a capacitance, the tip and capacitance switchable from a first state in which the tip coupled to the capacitance stimulates the capacitive touch screen surface to a second state in which the tip does not stimulate the capacitive touch screen surface; and,
support structure for supporting the application of the stylus tip to the capacitive touch screen surface.

16. The stylus of claim 15, wherein said tip is a felted tip that includes base fibers and conductive fibers felted with the base fibers.

17. The stylus of claim 15, wherein the tip coupled to the capacitance is passively switchable between the first state and the second state.

18. The stylus of claim 15, wherein the structure includes a conductive shaft, and said stylus also includes:
switched circuitry selectable between the first state that forms a low impedance path that couples an additional amount of capacitance to the tip, the combined capacitance sufficient to allow the capacitive touch screen to recognize a touch by the tip, and wherein the switched circuitry in the second state does not couple to sufficient additional capacitance to the tip to allow the capacitive touch screen to recognize a touch by the tip.

19. The stylus of claim 18, wherein the switched circuitry also includes a stylus audio port set, including at least one audio port configured to be coupled to an audio cable.

20. The stylus of claim 19, wherein the stylus audio port set includes at least one audio input port, and at least one audio output port.

21. The stylus of claim 19, wherein the stylus audio port set has a state indicative of contact between the tip and an object external to the stylus.

22. The stylus of claim 19, wherein the stylus audio port set has a state indicative of pressure exerted by an object on the tip.

23. The stylus of claim 19, wherein the switched circuitry includes at least one sensor, and the stylus audio port set has a state indicative state of the sensor.

24. The stylus of claim 19, wherein the stylus audio port set has a state indicative of state of at least one switch of the switched circuitry.

25. The stylus of claim 19, wherein the audio cable includes left and right output channel connectors, a microphone channel connector, and a ground connector, and the stylus audio port set is configured to be coupled to an end of the audio cable, such that another end of the cable can be coupled to a host audio port set of a capacitive touch screen device.

26. In a system having
a capacitive touch screen device comprising:
a capacitive touch screen surface;
a controller that defines a touch event on the capacitive touch screen surface by the touch event having at least a threshold contact area value and at least a threshold change in local capacitance value; and,
a stylus comprising:
a tip with a conductive surface coupled to a capacitance, the tip and capacitance switchable from a first state (tip down) in which the tip coupled to the capacitance stimulates the capacitive touch screen surface to a second state (tip up) in which the tip does not stimulate the capacitive touch screen surface,
a method comprising:
a) transmitting from the stylus to the capacitive touch screen device, a signal associated with a transition in the stylus from the tip up state to the tip down state and assigning a time T1 to that signal;
b) on the capacitive touch screen device, gathering all touch event data, including touch events, if any, associated with contact between the stylus tip in the tip down state and the capacitive touch screen;
c) for gathered touch events that occurred within a predetermined time interval relative to T1, creating a collection of unclassified touch event data; and
d) processing the collected unclassified touch event data to differentiate touch events likely caused by movement of the stylus tip in the tip down state from touch events likely caused by touches of the capacitive touch screen by objects other than the stylus.

27. A stylus, including:
tip with a deformable conductive surface; and
switched circuitry having a first state which couples additional capacitance to the tip, where the combined capacitance is sufficient to cause a change in a local electric field of a capacitive touch screen device sufficient to allow the device to recognize, as a touch, simple contact of the tip on of the capacitive touch screen device, wherein the switched circuitry also has a second state which decouples the additional capacitance from the tip, and the capacitance of the tip alone is insufficient to cause the capacitive touch screen device to recognize a touch by the tip.

28. The stylus of claim 27, wherein the conductive tip is a conductive, felted tip that is deformable, and includes base fibers and conductive fibers felted with the base fibers.

29. The stylus of claim 27, wherein the switched circuitry is passive switched circuitry.

30. The stylus of claim 27, wherein the capacitance is a capacitive load external to the stylus.

30. The stylus of claim 27, wherein the capacitance is internal to the stylus.

31. The stylus of claim 27, wherein the switched circuitry includes at least one switch biased in a default state which couples the additional capacitance to the tip but is switchable in response to movement of the tip into a second state which decouples the capacitance from said tip, where the switch is coupled to the tip in the default state.

32. The stylus of claim 27, wherein the switched circuitry includes at least one switch biased in a default state which decouples the additional capacitance from the tip but is switchable in response to movement of the tip into a second state which couples the additional capacitance to said tip, where the switch is coupled to the tip in the second state.

33. The stylus of claim 27, wherein the switched circuitry also includes a stylus audio port set, including at least one audio port configured to be coupled to an audio cable.

34. The stylus of claim 27, wherein the switched circuitry includes at least one variable circuit element whose state is determined by sensor input.

35. The stylus of claim 34, wherein the switched circuitry also includes an audio port set, including at least one audio port configured to be coupled to an audio cable, and the switched circuitry is configured to assert to the audio port set a response signal indicative of state of the variable circuit element.
